(19) United States
(12) Patent Application Publication
(10) Pub. No.: US 2025/0274257 A1
(43) Pub. Date: Aug. 28, 2025

(54) SUBBAND CONFIGURATION TECHNIQUES FOR SUBBAND FULL DUPLEX

(71) Applicant: QUALCOMM Incorporated, San Diego, CA (US)

(72) Inventors: Muhammad Sayed Khairy ABDELGHAFFAR, San Jose, CA (US); Peter GAAL, San Diego, CA (US); Abdelrahman Mohamed IBRAHIM, San Diego, CA (US)

(21) Appl. No.: 19/052,823

(22) Filed: Feb. 13, 2025

Related U.S. Application Data
(60) Provisional application No. 63/557,384, filed on Feb. 23, 2024.

(51) Int. Cl. H04L 5/14; H04L 5/00

(52) U.S. Cl. CPC H04L 5/14; H04L 5/0094

(57) ABSTRACT

Methods, systems, and devices for wireless communications are described. A wireless device such as a user equipment (UE) may receive first information indicative of one or more bandwidth part (BWP) pairs configured for the UE, where each BWP pair includes a respective uplink BWP and a respective downlink BWP. The one or more BWP pairs may be active uplink and downlink BWPs that at least partially occupy a channel bandwidth of the UE. The UE may then receive second information indicative of a subband full duplex (SBFD) configuration for each of the one or more BWP pairs, where the SBFD configuration indicates an uplink subband, a downlink subband or both, that corresponds to each of the one or more BWP pairs, and are dedicated for the SBFD communications. The UE may then communicate one or more messages via the one or more BWP pairs in accordance with the SBFD configuration.

### CROSS REFERENCE

The present application for patent claims benefit of U.S. Provisional Patent Application No. 63/557,384 by Abdelghaffar et al., entitled “Subband Configuration Techniques for Subband Full Duplex,” filed Feb. 23, 2024, assigned to the assignee hereof, and expressly incorporated herein.

### FIELD OF TECHNOLOGY

The following relates to wireless communications, including subband configuration techniques for subband full duplex (SBFD).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support subband configuration techniques for subband full duplex (SBFD). For example, the described techniques provide for per-bandwidth part (BWP) or cell-specific SBFD configurations. A wireless device such as a user equipment (UE) may receive first information that indicates one or more BWP pairs configured for the UE, where each BWP pair includes a respective uplink BWP and a respective downlink BWP. The one or more BWP pairs may be active or initial uplink and downlink BWPs that at least partially occupy a channel bandwidth of the UE. The UE may then receive second information that indicates a SBFD configuration for each of the one or more BWP pairs, where the SBFD configuration indicates an uplink subband, a downlink subband or both, that correspond to each of the one or more BWP pairs, and are dedicated for the SBFD communications. The UE may then communicate one or more messages via the one or more BWP pairs in accordance with the SBFD configuration. In some other implementations, the UE may receive a cell-specific SBFD configuration, based on a cell-specific channel bandwidth or a UE-specific channel bandwidth.

A method for wireless communications by a UE is described. The method may include receiving first information indicative of one or more BWP pairs configured for the UE, each BWP pair of the one or more BWP pairs including a respective uplink BWP and a respective downlink BWP that at least partially occupy a channel bandwidth of the UE, receiving second information indicative of a SBFD configuration for each of the one or more BWP pairs, where the SBFD configuration indicates an uplink subband, a downlink subband or both, that corresponds to each of the one or more BWP pairs, and communicating one or more messages via the one or more BWP pairs in accordance with the SBFD configuration.

A UE for wireless communications is described. The UE may include one or more memories storing processor executable code, and one or more processors coupled with the one or more memories. The one or more processors may individually or collectively be operable to execute the code to cause the UE to receive first information indicative of one or more BWP pairs configured for the UE, each BWP pair of the one or more BWP pairs including a respective uplink BWP and a respective downlink BWP that at least partially occupy a channel bandwidth of the UE, receive second information indicative of a SBFD configuration for each of the one or more BWP pairs, where the SBFD configuration indicates an uplink subband, a downlink subband or both, that corresponds to each of the one or more BWP pairs, and communicate one or more messages via the one or more BWP pairs in accordance with the SBFD configuration.

Another UE for wireless communications is described. The UE may include means for receiving first information indicative of one or more BWP pairs configured for the UE, each BWP pair of the one or more BWP pairs including a respective uplink BWP and a respective downlink BWP that at least partially occupy a channel bandwidth of the UE, means for receiving second information indicative of a SBFD configuration for each of the one or more BWP pairs, where the SBFD configuration indicates an uplink subband, a downlink subband or both, that corresponds to each of the one or more BWP pairs, and means for communicating one or more messages via the one or more BWP pairs in accordance with the SBFD configuration.

A non-transitory computer-readable medium storing code for wireless communications is described. The code may include instructions executable by one or more processors to receive first information indicative of one or more BWP pairs configured for the UE, each BWP pair of the one or more BWP pairs including a respective uplink BWP and a respective downlink BWP that at least partially occupy a channel bandwidth of the UE, receive second information indicative of a SBFD configuration for each of the one or more BWP pairs, where the SBFD configuration indicates an uplink subband, a downlink subband or both, that corresponds to each of the one or more BWP pairs, and communicate one or more messages via the one or more BWP pairs in accordance with the SBFD configuration.

In some examples of the method, UEs, and non-transitory computer-readable medium described herein, receiving the second information may include operations, features, means, or instructions for transmitting an indication of one or more capabilities of the UE and receiving, responsive to the indication, the second information indicative of the SBFD configuration, where the SBFD configuration may be based on the one or more capabilities of the UE.

In some examples of the method, UEs, and non-transitory computer-readable medium described herein, the SBFD configuration includes a resource indication value (RIV) that indicates a resource allocation associated with the uplink subband, the downlink subband or both and the RIV includes an indication of a starting resource block of the resource allocation and a quantity of resource blocks included in the resource allocation.

In some examples of the method, UEs, and non-transitory computer-readable medium described herein, the starting resource block may be indicated relative to a first physical resource block (PRB) of a carrier bandwidth.

In some examples of the method, UEs, and non-transitory computer-readable medium described herein, the starting resource block may be indicated relative to a first PRB of an active BWP of the one or more BWP pairs of the channel bandwidth of the UE.

In some examples of the method, UEs, and non-transitory computer-readable medium described herein, the uplink subband, the downlink subband, or both, may be configured in an active BWP pair of the one or more BWP pairs.

In some examples of the method, UEs, and non-transitory computer-readable medium described herein, the SBFD configuration may be based on one or more capabilities of the UE, the one or more capabilities including a supported guard band size between the uplink subband and the downlink subband, a threshold size of the uplink subband, a threshold size of the downlink subband, or any combination thereof.

In some examples of the method, UEs, and non-transitory computer-readable medium described herein, receiving the second information indicative of the SBFD configuration may include operations, features, means, or instructions for receiving an indication of a resource allocation of a scheduled physical channel for SBFD communications via a bitmap, where a resource block group size of the resource allocation may be based on a size of the uplink subband, a size of the downlink subband, or both.

In some examples of the method, UEs, and non-transitory computer-readable medium described herein, receiving the second information indicative of the SBFD configuration may include operations, features, means, or instructions for receiving an indication of a resource allocation of a scheduled physical channel at the uplink subband, the downlink subband or both, where the resource allocation of the scheduled physical channel includes a RIV that includes an indication of a starting resource block of the resource allocation that may be with reference to a first resource block of the uplink subband or a first resource block of the downlink subband.

In some examples of the method, UEs, and non-transitory computer-readable medium described herein, receiving the second information indicative of the SBFD configuration may include operations, features, means, or instructions for receiving an indication of a physical channel resource allocation configured with frequency hopping within the downlink subband, the uplink subband, or both, where the physical channel resource allocation indicates a starting resource block of each hop of the frequency hopping relative to a first resource block of the uplink subband, and where a resource block offset may be based on a size of the uplink subband, the downlink subband, or both.

In some examples of the method, UEs, and non-transitory computer-readable medium described herein, receiving the second information indicative of the SBFD configuration may include operations, features, means, or instructions for receiving the second information indicative of the SBFD configuration in respective uplink and downlink BWP configurations for the uplink subband, the downlink subband, or both, where the SBFD configuration may be indicated jointly in each uplink and downlink BWP configuration, or separately for each uplink and downlink BWP configuration.

In some examples of the method, UEs, and non-transitory computer-readable medium described herein, the SBFD configuration includes frequency location information for the uplink subband, the downlink subband, or both, one or more RIVs, subcarrier spacing information, time domain information, semi-persistent scheduling information, one or more uplink channel configurations, one or more downlink channel configurations, one or more uplink reference signal configurations, one or more downlink reference signal configurations or any combination thereof.

In some examples of the method, UEs, and non-transitory computer-readable medium described herein, the SBFD configuration including the uplink subband, the downlink subband or both, may be configured in accordance with a common resource block grid of a cell configured for SBFD communications.

In some examples of the method, UEs, and non-transitory computer-readable medium described herein, the cell includes a network carrier and an associated network carrier bandwidth, a carrier of the UE and the channel bandwidth of the UE, or both.

In some examples of the method, UEs, and non-transitory computer-readable medium described herein, communicating the one or more messages may include operations, features, means, or instructions for communicating the one or more messages via frequency resources of the uplink subband, the downlink subband, or both, based on one or more PRBs that at least partially overlap with the respective uplink BWP, the respective downlink BWP, or both, of the SBFD configuration.

Some examples of the method, UEs, and non-transitory computer-readable medium described herein may further include operations, features, means, or instructions for dropping one or more PRBs of the respective uplink BWP, the respective downlink BWP, or both, based on a subcarrier spacing of the respective uplink BWP, the respective downlink BWP, or both, being greater than a corresponding subcarrier spacing of the uplink subband, the downlink subband, or both.

In some examples of the method, UEs, and non-transitory computer-readable medium described herein, receiving the second information indicative of the SBFD configuration may include operations, features, means, or instructions for receiving, while the UE may be in a connected state, the second information indicative of the SBFD configuration via a serving cell configuration message, where the SBFD configuration includes a time pattern or an indication of resources for SBFD communications.

In some examples of the method, UEs, and non-transitory computer-readable medium described herein, receiving the second information indicative of the SBFD configuration may include operations, features, means, or instructions for receiving, while the UE may be in a connected state, the second information indicative of the SBFD configuration for each of the one or more BWP pairs, where the SBFD configuration includes a time pattern or an indication of resources for SBFD communications.

In some examples of the method, UEs, and non-transitory computer-readable medium described herein, receiving the second information indicative of the SBFD configuration may include operations, features, means, or instructions for receiving, while the UE may be in a connected state, an idle state, or an inactive state, the second information indicative of the SBFD configuration via a cell common configuration of a broadcast message, where the SBFD configuration includes a time pattern or an indication of resources for SBFD communications.

Some examples of the method, UEs, and non-transitory computer-readable medium described herein may further include operations, features, means, or instructions for receiving the SBFD configuration includes a SBFD pattern periodicity that may be based on a time division duplexing (TDD) downlink and uplink periodicity.

In some examples of the method, UEs, and non-transitory computer-readable medium described herein, the UE may be operating in an inactive state or an idle state, and receiving the second information indicative of the SBFD configuration may include operations, features, means, or instructions for receiving the second information indicative of the SBFD configuration via one or more broadcast system information messages, where the uplink subband, the downlink subband, or both, may be configured relative to an initial BWP, may be configured based on a serving cell bandwidth, or both.

A method for wireless communications by a network entity is described. The method may include outputting first information indicative of one or more BWP pairs configured for a UE, each BWP pair of the one or more BWP pairs including a respective uplink BWP and a respective downlink BWP that at least partially occupy a channel bandwidth of the UE, outputting second information indicative of a SBFD configuration for each of the one or more BWP pairs, where the SBFD configuration indicates an uplink subband, a downlink subband or both, that corresponds to each of the one or more BWP pairs, and communicating one or more messages via the one or more BWP pairs in accordance with the SBFD configuration.

A network entity for wireless communications is described. The network entity may include one or more memories storing processor executable code, and one or more processors coupled with the one or more memories. The one or more processors may individually or collectively be operable to execute the code to cause the network entity to output first information indicative of one or more BWP pairs configured for a UE, each BWP pair of the one or more BWP pairs including a respective uplink BWP and a respective downlink BWP that at least partially occupy a channel bandwidth of the UE, output second information indicative of a SBFD configuration for each of the one or more BWP pairs, where the SBFD configuration indicates an uplink subband, a downlink subband or both, that corresponds to each of the one or more BWP pairs, and communicate one or more messages via the one or more BWP pairs in accordance with the SBFD configuration.

Another network entity for wireless communications is described. The network entity may include means for outputting first information indicative of one or more BWP pairs configured for a UE, each BWP pair of the one or more BWP pairs including a respective uplink BWP and a respective downlink BWP that at least partially occupy a channel bandwidth of the UE, means for outputting second information indicative of a SBFD configuration for each of the one or more BWP pairs, where the SBFD configuration indicates an uplink subband, a downlink subband or both, that corresponds to each of the one or more BWP pairs, and means for communicating one or more messages via the one or more BWP pairs in accordance with the SBFD configuration.

A non-transitory computer-readable medium storing code for wireless communications is described. The code may include instructions executable by one or more processors to output first information indicative of one or more BWP pairs configured for a UE, each BWP pair of the one or more BWP pairs including a respective uplink BWP and a respective downlink BWP that at least partially occupy a channel bandwidth of the UE, output second information indicative of a SBFD configuration for each of the one or more BWP pairs, where the SBFD configuration indicates an uplink subband, a downlink subband or both, that corresponds to each of the one or more BWP pairs, and communicate one or more messages via the one or more BWP pairs in accordance with the SBFD configuration.

In some examples of the method, network entities, and non-transitory computer-readable medium described herein, outputting the second information may include operations, features, means, or instructions for obtaining an indication of one or more capabilities of the UE and outputting, responsive to the indication, the second information indicative of the SBFD configuration, where the SBFD configuration may be based on the one or more capabilities of the UE.

In some examples of the method, network entities, and non-transitory computer-readable medium described herein, the SBFD configuration includes a RIV that indicates a resource allocation associated with the uplink subband, the downlink subband or both and the RIV includes an indication of a starting resource block of the resource allocation and a quantity of resource blocks included in the resource allocation.

In some examples of the method, network entities, and non-transitory computer-readable medium described herein, the starting resource block may be indicated relative to a first PRB of a carrier bandwidth.

In some examples of the method, network entities, and non-transitory computer-readable medium described herein, the starting resource block may be indicated relative to a first PRB of an active BWP of the one or more BWP pairs of the channel bandwidth of the UE.

In some examples of the method, network entities, and non-transitory computer-readable medium described herein, the uplink subband, the downlink subband, or both, may be configured in an active BWP pair of the one or more BWP pairs.

In some examples of the method, network entities, and non-transitory computer-readable medium described herein, the SBFD configuration may be based on one or more capabilities of the UE, the one or more capabilities including a supported guard band size between the uplink subband and the downlink subband, a threshold size of the uplink subband, a threshold size of the downlink subband, or any combination thereof.

In some examples of the method, network entities, and non-transitory computer-readable medium described herein, outputting the second information indicative of the SBFD configuration may include operations, features, means, or instructions for outputting an indication of a resource allocation of a scheduled physical channel for SBFD communications via a bitmap, where a resource block group size of the resource allocation may be based on a size of the uplink subband, a size of the downlink subband, or both.

In some examples of the method, network entities, and non-transitory computer-readable medium described herein, outputting the second information indicative of the SBFD configuration may include operations, features, means, or instructions for receiving an indication of a resource allocation of a scheduled physical channel at the uplink subband, the downlink subband or both, where the resource allocation of the scheduled physical channel includes a RIV that includes an indication of a starting resource block of the resource allocation that may be with reference to a first resource block of the uplink subband or a first resource block of the downlink subband.

In some examples of the method, network entities, and non-transitory computer-readable medium described herein, outputting the second information indicative of the SBFD configuration may include operations, features, means, or instructions for outputting an indication of a physical channel resource allocation configured with frequency hopping within the downlink subband, the uplink subband, or both, where the physical channel resource allocation indicates a starting resource block of each hop of the frequency hopping relative to a first resource block of the uplink subband, and where a resource block offset may be based on a size of the uplink subband, the downlink subband, or both.

In some examples of the method, network entities, and non-transitory computer-readable medium described herein, outputting the second information indicative of the SBFD configuration may include operations, features, means, or instructions for outputting the second information indicative of the SBFD configuration in respective uplink and downlink BWP configurations for the uplink subband, the downlink subband, or both, where the SBFD configuration may be indicated jointly in each uplink and downlink BWP configuration, or separately for each uplink and downlink BWP configuration.

In some examples of the method, network entities, and non-transitory computer-readable medium described herein, the SBFD configuration includes frequency location information for the uplink subband, the downlink subband, or both, one or more RIVs, subcarrier spacing information, time domain information, semi-persistent scheduling information, one or more uplink channel configurations, one or more downlink channel configurations, one or more uplink reference signal configurations, one or more downlink reference signal configurations or any combination thereof.

In some examples of the method, network entities, and non-transitory computer-readable medium described herein, the SBFD configuration including the uplink subband, the downlink subband or both, may be configured in accordance with a common resource block grid of a cell configured for SBFD communications.

In some examples of the method, network entities, and non-transitory computer-readable medium described herein, the cell includes a network carrier and an associated network carrier bandwidth, a carrier of the UE and the channel bandwidth of the UE, or both.

In some examples of the method, network entities, and non-transitory computer-readable medium described herein, communicating the one or more messages may include operations, features, means, or instructions for communicating the one or more messages via frequency resources of the uplink subband, the downlink subband, or both, based on one or more PRBs that at least partially overlap with the respective uplink BWP, the respective downlink BWP, or both, of the SBFD configuration.

In some examples of the method, network entities, and non-transitory computer-readable medium described herein, outputting the second information indicative of the SBFD configuration may include operations, features, means, or instructions for outputting, while the UE may be in a connected state, the second information indicative of the SBFD configuration via a serving cell configuration message, where the SBFD configuration includes a time pattern or an indication of resources for SBFD communications.

In some examples of the method, network entities, and non-transitory computer-readable medium described herein, outputting the second information indicative of the SBFD configuration may include operations, features, means, or instructions for outputting, while the UE may be in a connected state, the second information indicative of the SBFD configuration for each of the one or more BWP pairs, where the SBFD configuration includes a time pattern or an indication of resources for SBFD communications.

In some examples of the method, network entities, and non-transitory computer-readable medium described herein, receiving the second information indicative of the SBFD configuration may include operations, features, means, or instructions for outputting, while the UE may be in a connected state, an idle state, or an inactive state, the second information indicative of the SBFD configuration via a cell common configuration of a broadcast message, where the SBFD configuration includes a time pattern or an indication of resources for SBFD communications.

Some examples of the method, network entities, and non-transitory computer-readable medium described herein may further include operations, features, means, or instructions for outputting the SBFD configuration includes a SBFD pattern periodicity that may be based on a TDD downlink and uplink periodicity.

In some examples of the method, network entities, and non-transitory computer-readable medium described herein, outputting the second information indicative of the SBFD configuration may include operations, features, means, or instructions for outputting the second information indicative of the SBFD configuration via one or more broadcast system information messages, where the uplink subband, the downlink subband, or both, may be configured relative to an initial BWP, may be configured based on a serving cell bandwidth, or both.

### BRIEF DESCRIPTION OF THE DRAWINGS

FIGS. 1 and 2 show examples of wireless communications systems that support subband configuration techniques for subband full duplex (SBFD) in accordance with one or more aspects of the present disclosure.

FIGS. 3, 4, 5, and 6 show examples of SBFD configurations that support subband configuration techniques for SBFD in accordance with one or more aspects of the present disclosure.

FIG. 7 shows an example of a wireless communications system that supports subband configuration techniques for SBFD in accordance with one or more aspects of the present disclosure.

FIGS. 8, 9, and 10 show examples of SBFD configurations that support subband configuration techniques for SBFD in accordance with one or more aspects of the present disclosure.

FIG. 11 shows an example of a process flow that supports subband configuration techniques for SBFD in accordance with one or more aspects of the present disclosure.

FIGS. 12 and 13 show block diagrams of devices that support subband configuration techniques for SBFD in accordance with one or more aspects of the present disclosure.

FIG. 14 shows a block diagram of a communications manager that supports subband configuration techniques for SBFD in accordance with one or more aspects of the present disclosure.

FIG. 15 shows a diagram of a system including a device that supports subband configuration techniques for SBFD in accordance with one or more aspects of the present disclosure.

FIGS. 16 and 17 show block diagrams of devices that support subband configuration techniques for SBFD in accordance with one or more aspects of the present disclosure.

FIG. 18 shows a block diagram of a communications manager that supports subband configuration techniques for SBFD in accordance with one or more aspects of the present disclosure.

FIG. 19 shows a diagram of a system including a device that supports subband configuration techniques for SBFD in accordance with one or more aspects of the present disclosure.

FIGS. 20 through 22 show flowcharts illustrating methods that support subband configuration techniques for SBFD in accordance with one or more aspects of the present disclosure.

### DETAILED DESCRIPTION

Some wireless communications systems may support subband full duplex (SBFD) communications, where a carrier (such as a cell-specific carrier or a user equipment (UE)-specific carrier) may be partitioned into one or more subbands for downlink communications, uplink communications, or both. In some cases, SBFD techniques may allow downlink and uplink communications on corresponding downlink and uplink subbands to occur simultaneously (e.g., at the same time) in a same slot. For example, a network entity may allocate a set of frequency resources (such as a set of dedicated uplink and downlink subbands) within a channel, which may be used by devices to perform SBFD uplink and downlink communications. In some implementations, the SBFD communications may occur within one or more active bandwidth parts (BWPs) configured for a UE, such that the UE may receive downlink communications using downlink subband frequency resources within an active downlink BWP, and may transmit uplink communications using corresponding uplink subband frequency resources in an active uplink BWP. In some cases, however, the UE may be unaware of which uplink and downlink resources to use for SBFD communications, including uplink and downlink subbands within one or more active BWPs, or which resources out of a set of indicated resources are available to use for SBFD.

To support efficient SBFD resource allocation and communication within a wireless communications system, the network entity may configure an uplink and downlink SBFD configuration for each uplink and downlink BWP pair (including at least one uplink BWP and one downlink BWP) configured for the UE, or a cell-specific uplink and downlink SBFD configuration. For example, the uplink and downlink SBFD configuration may be indicative of a resource allocation associated with SBFD communications for the UE per uplink and downlink BWP pair, where the resource allocation indicates different dedicated SBFD uplink and downlink subbands that correspond to each uplink and downlink BWP within the channel bandwidth of the UE.

In some cases, the SBFD configuration may be based on (or configured to support) one or more capabilities of the UE, may be based on an operating mode of the UE (including radio resource control (RRC) connected modes and idle or inactive modes of the UE), may be based on UE guard band size or configured subband size, among other supported UE capabilities. In some aspects, the uplink and downlink SBFD configuration may allow the UE to efficiently determine a frequency location and associated configuration for the one or more uplink and downlink subbands in each active uplink or downlink BWP.

The techniques described herein may be implemented to realize one or more potential advantages. For example, SBFD techniques, when implemented by the network and the UE, may increase system throughput based on increased opportunities to transmit and receive uplink and downlink communications (e.g., simultaneous uplink and downlink communications). Additionally, or alternatively, the techniques described herein may increase uplink and downlink coverage and signaling reliability for the UE, and may reduce latency of both uplink and downlink communications based on the SBFD configuration, where the UE may be aware of dedicated uplink and downlink subbands for SBFD communications within each active BWP allocated to the UE.

Aspects of the disclosure are initially described in the context of wireless communications systems. Aspects of the disclosure are further illustrated by and described with reference to SBFD configurations, a process flow, apparatus diagrams, system diagrams, and flowcharts that relate to subband configuration techniques for SBFD.

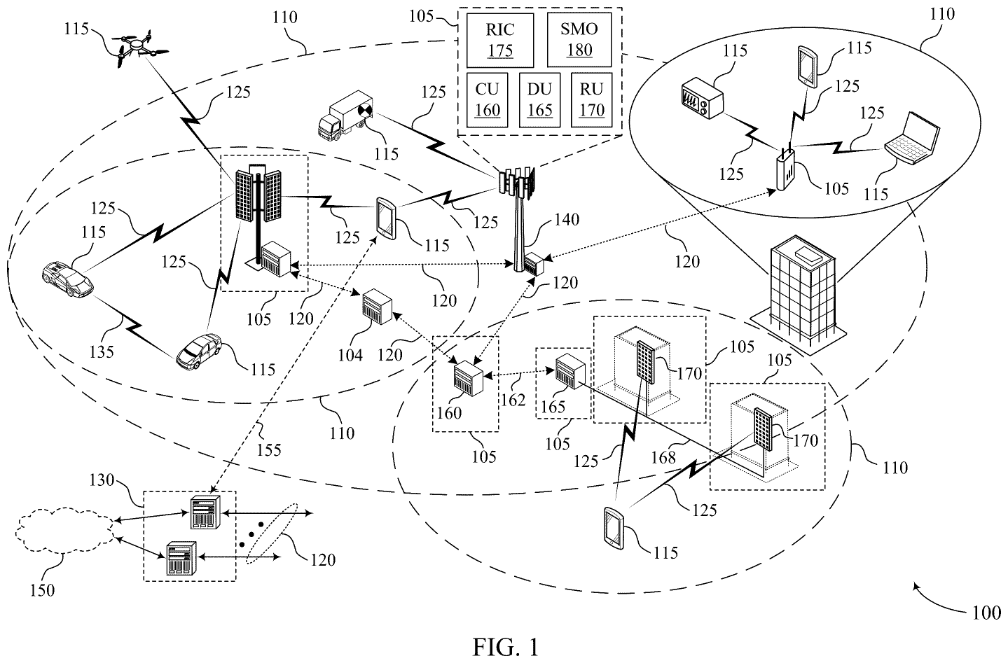

FIG. 1 shows an example of a wireless communications system 100 that supports subband configuration techniques for SBFD in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 and a network entity 105 may operate using a set of frequency resources of a frequency band (e.g., FR1). For example, a carrier or operator may be allocated a subset of a total operating band, and the channel bandwidth of the carrier may be allocated as a cell-specific bandwidth of a cell associated with the network entity 105. In some examples, the UE 115 may be allocated a set of resources of the cell-specific bandwidth, where the UE-specific channel bandwidth may be different from or the same as the cell-specific bandwidth. For example, the UE 115 may support a maximum bandwidth of 60 MHz (or another maximum bandwidth) while the network entity 105 may support a channel bandwidth that is 100 MHz (or another maximum bandwidth that is greater than or equal to the UE bandwidth). In such examples, the UE 115 may be assigned or configured to operate in an operating bandwidth of up to 60 MHz that is a portion or subset of the channel bandwidth of the network entity 105.

In some implementations, the UE-specific channel bandwidth (and channel allocation) may be configured in a serving cell configuration (e.g., as ‘downlinkChannelBW-PerSCS-List’ and ‘uplinkChannelBW-PerSCS-List’ of the ‘servingCellConfig’) after the UE 115 performs RRC connection with the cell. The UE 115 may set the channel bandwidth to operate in compliance with various communications regulations. Additionally, or alternatively, the cell-specific carrier bandwidth and carrier location may be indicated via one or more parameters (e.g., SCS-SpecificCarrier) that may be included in one or more broadcast messages (e.g., SIB1). The UE 115 may use the information in the one or more broadcast messages to determine where the PRBs are located in relation to a reference point, and whether the BWP configuration is intended for the UE 115 (or for one or more other UEs in the network).

Wireless communications system 100 may support SBFD communications, where an allocated frequency band may be partitioned into one or more subbands for downlink communications, uplink communications, or both. In some cases, SBFD techniques may allow downlink and uplink communications on corresponding downlink and uplink subbands to occur simultaneously. In some implementations, the SBFD communications may occur within one or more active BWPs configured for a UE 115, where the UE 115 (which may have SBFD capabilities such as half duplex capabilities, full duplex capabilities, or both) may receive downlink communications using downlink subband frequency resources within an active downlink BWP, and may transmit uplink communications using corresponding uplink subband frequency resources in an active uplink BWP. In some cases, however, the UE 115 may be unaware of which uplink and downlink resources to use for SBFD communications, including uplink and downlink subbands within one or more active or initial BWPs, or which resources out of a set of indicated resources are available to use for SBFD.

To support efficient SBFD resource allocation and communication within a wireless communications system, the network entity may configure an uplink and downlink SBFD configuration for each uplink and downlink BWP pair (including at least one uplink BWP and one downlink BWP) configured for the UE 115, or a cell-specific uplink and downlink SBFD configuration. For example, the uplink and downlink SBFD configuration may indicate different dedicated SBFD uplink and downlink subbands that correspond to each uplink and downlink BWP within the channel bandwidth of the UE 115.

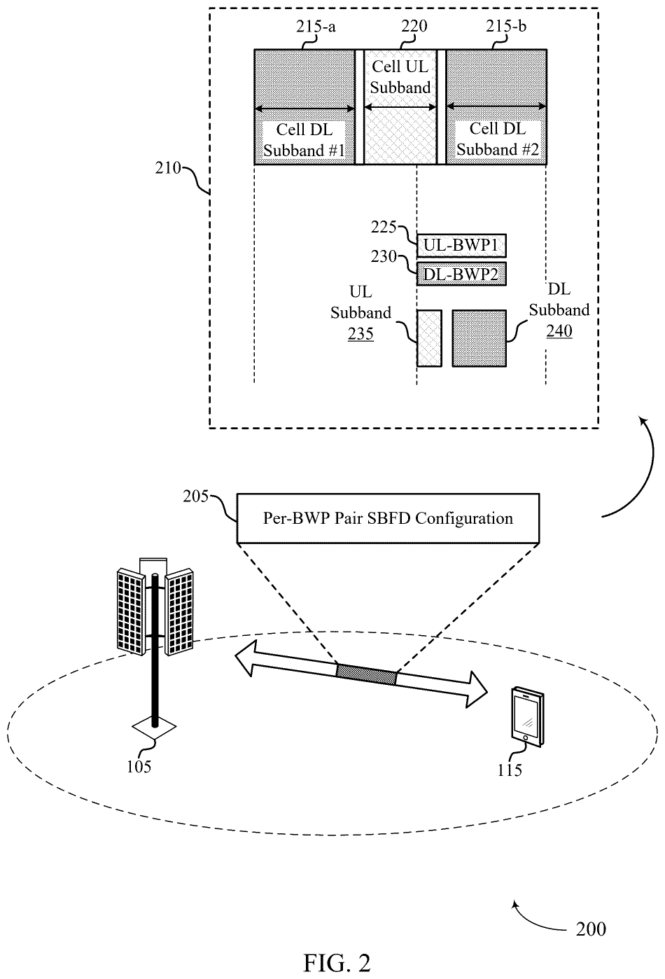

FIG. 2 shows an example of a wireless communications system 200 that supports subband configuration techniques for SBFD in accordance with one or more aspects of the present disclosure. For example, the wireless communications system 200 may illustrate communications between a network entity 105 and a UE 115, each of which may be examples of corresponding network entities 105 and UEs 115 as described with reference to FIG. 1. In some examples, the UE 115 and network entity 105 may support SBFD communications including uplink and downlink signaling in an allocated frequency band.

For example, the wireless communications system 200 may support SBFD communications in which a single frequency band may be partitioned into one or more sub-bands for downlink communications, uplink communications, or both, which may occur simultaneously (e.g., at the same time, using one or more same time resources) in a same slot. Some SBFD techniques, when implemented by the network entity 105 and the UE 115, may increase system throughput, increase uplink and downlink coverage for the UE 115, and may reduce latency of both uplink and downlink communications.

The network entity 105 may allocate a set of frequencies within a channel bandwidth (or a component carrier bandwidth) into one or more downlink subbands, one or more uplink subbands, and one or more corresponding guard bands in between the one or more downlink subbands and the one or more uplink subbands. For example, for an SBFD configuration including the one or more downlink subbands, the one or more uplink subbands and the one or more guard bands may indicate a non-overlapping SBFD configuration. In some aspects, SBFD communications may occur within one or more active BWPs, where the UE 115 may receive downlink communications using downlink subband frequency resources within an active downlink BWP, and may transmit uplink communications using corresponding uplink subband frequency resources in an active uplink BWP. In some implementations, however, the UE 115 may be unaware of which uplink and downlink resources to use for SBFD communications, including uplink and downlink subbands within one or more active BWPs, or which resources out of a set of indicated resources are available to use for SBFD.

In some examples, the network entity 105 may signal or otherwise indicate an uplink and downlink SBFD configuration as a single cell-common configuration, or using a per-BWP configuration. For the single cell-common configuration, the downlink and uplink subbands may be defined within a channel bandwidth of the carrier (e.g., either a cell-specific network carrier bandwidth, or a UE-specific carrier bandwidth, where the network carrier bandwidth and the UE-specific carrier bandwidth may be different). For an SBFD configuration per-BWP, the network entity 105 may convey multiple SBFD configurations for each BWP allocated for the UE 115, for example, the UE 115 may have one or more dedicated downlink and uplink subbands for each corresponding downlink and uplink BWP configured for the UE 115. In such examples, the downlink and uplink subbands may be located within the active uplink and downlink BWPs of the UE 115, such that the UE 115 may utilize the uplink and downlink resources within the active uplink and downlink BWPs.

To support efficient SBFD resource allocation and communication within a wireless communications system, the network entity 105 may configure the uplink and downlink SBFD configuration 205 for each uplink and downlink BWP pair (including uplink BWP 225 and downlink BWP 230) configured for the UE 115. In some implementations, the uplink and downlink SBFD configuration 205 may be indicative of a resource allocation 210 associated with SBFD communications for the UE 115. The network entity 105 may support a cell bandwidth that includes a cell downlink subband 215-a, a cell uplink subband 220, and a cell downlink subband 215-b. The UE 115 may be configured with one or more uplink and downlink BWP pairs (one of which may include uplink BWP 225 and downlink BWP 230) within a UE-specific carrier bandwidth (which includes at least a portion of the cell bandwidth), and may receive one or more uplink and downlink SBFD configurations that configure different SBFD uplink and downlink subbands (e.g., uplink subband 235 and downlink subband 240) that correspond to each uplink and downlink BWP pair within the channel bandwidth of the UE 115. For example, the UE 115 may have a dedicated set of subbands, including uplink subband 235 and downlink subband 240, that may span the same frequency as the uplink and downlink BWP pair. In some cases, the dedicated set of subbands may correspond to the set of cell-specific subbands. For example, the uplink BWP 225 overlaps with the cell uplink subband 220, and the corresponding SBFD uplink subband for the UE 115 includes the overlapped portion of the uplink BWP 225 and the cell uplink subband 220. In addition, the downlink BWP 230 overlaps with the cell downlink subband 215-b, so the downlink subband 240 (e.g., a corresponding SBFD downlink subband) includes the overlapped portion of the downlink BWP 230 and the cell downlink subband 215-b.

In some cases, the SBFD configuration may be based on (or configured to support) one or more capabilities of the UE 115, may be configured based on an operating mode of the UE 115 (including RRC connected modes and idle or inactive modes of the UE 115), UE required guard band size, subband size requirements, among other supported UE capabilities. The uplink and downlink SBFD configuration 205 may allow the UE 115 to efficiently determine a frequency location and associated configuration for the one or more uplink and downlink subbands in each allocated uplink or downlink BWP.

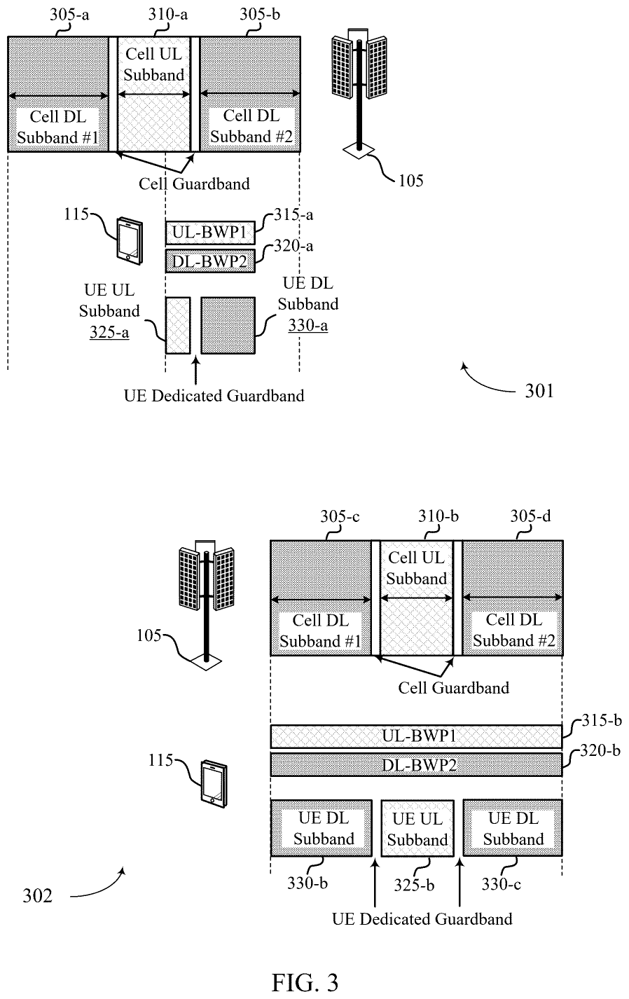

FIG. 3 shows an example of SBFD configuration 301 and SBFD configuration 302 that support subband configuration techniques for SBFD in accordance with one or more aspects of the present disclosure. For example, the SBFD configuration 301 and the SBFD configuration 302 may be implemented at or by aspects of wireless communications system 100 and wireless communications system 200, described with reference to FIGS. 1 and 2. For example, the SBFD configuration 301 and the SBFD configuration 302 may be configured by a network entity 105, and may be implemented by a UE 115, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some examples of the SBFD configuration 301 and the SBFD configuration 302, the network entity 105 may configure both uplink and downlink SBFD communications for each BWP pair supported by the UE 115. For example, the SBFD configuration 301 may illustrate an example BWP pair configuration including uplink BWP 315-a and downlink BWP 320-a, which may be configured for the UE 115 within (at least) a portion of the cell bandwidth supported by the network entity 105, including a first cell downlink subband 305-a, a cell uplink subband 310-a, and a second cell downlink subband 305-b, which may be separated from one another by a cell guard band.

In some examples, the UE 115 may operate within a UE-specific carrier bandwidth (which includes at least a portion of the cell bandwidth), and may receive one or more uplink and downlink SBFD configurations that configure different SBFD uplink and downlink subbands (e.g., dedicated uplink subband 325-a and dedicated downlink subband 330-a) that correspond to each uplink and downlink BWP pair within the channel bandwidth of the UE 115. For example, the UE 115 may have a dedicated set of subbands, including dedicated uplink subband 325-a and dedicated downlink subband 330-a that may span the same frequency as the uplink and downlink BWP pair. In some cases, the set of dedicated subbands (e.g., dedicated uplink subband 325-a and dedicated downlink subband 330-a) may correspond to the set of cell-specific subbands. For example, the uplink BWP 315-a (which may be an active uplink BWP for the UE 115) may overlap with the cell uplink subband 310-a, and the corresponding SBFD uplink subband for the UE 115 (e.g., dedicated uplink subband 325-a) includes uplink resources located within the overlapped portion of the uplink BWP 315-a and the cell uplink subband 310-a. In addition, the downlink BWP 320-a (which may be an active downlink BWP for the UE 115) overlaps with the second cell downlink subband 305-b, so the dedicated downlink subband 330-a includes resources of the overlapped portion of the downlink BWP 320-a and the second cell downlink subband 305-b. In some examples, since the dedicated downlink subband 330-a and the dedicated uplink subband 325-a are located within the active uplink and downlink BWPs for the UE 115, the UE 115 may identify resources of the dedicated subbands as usable resources (e.g., resources allocated for the UE 115 that are available or otherwise usable by the UE 115). Additionally, or alternatively, the dedicated downlink subband 330-a and the dedicated uplink subband 325-a may be separated by a UE dedicated guard band, which may be configured based on various parameters, such as one or more UE capabilities.

The SBFD configuration 302 may illustrate another example BWP pair configuration for the UE 115 that includes uplink BWP 315-b and downlink BWP 320-b, which may be configured for the UE 115 within (at least) a portion of the cell bandwidth supported by the network entity 105, including a first cell downlink subband 305-c, a cell uplink subband 310-b, and a second cell downlink subband 305-d, which may be separated from one another by a cell guard band.

In some examples, the UE 115 may operate within a UE-specific carrier bandwidth (which includes at least a portion of the cell bandwidth), and may receive one or more uplink and downlink SBFD configurations that configure different SBFD uplink and downlink subbands per BWP (e.g., dedicated uplink subband 325-b, a first dedicated downlink subband 330-b, and a second dedicated downlink subband 330-c) that correspond to each uplink and downlink BWP pair within the channel bandwidth of the UE 115. For example, the UE 115 may be configured a dedicated set of subbands, including dedicated uplink subband 325-b, the first dedicated downlink subband 330-b, and the second dedicated downlink subband 330-c, that may span the same frequency as the uplink and downlink BWP pair. In some cases, the set of dedicated subbands (e.g., dedicated uplink subband 325-b, the first dedicated downlink subband 330-b, and the second dedicated downlink subband 330-c) may correspond to the set of cell-specific subbands. For example, the uplink BWP 315-b (which may be an active uplink BWP for the UE 115) may fully overlap with the cell uplink subband 310-b, and the corresponding SBFD uplink subband for the UE 115 (e.g., dedicated uplink subband 325-b) includes uplink resources located within the overlapped portion of the uplink BWP 315-b and the cell uplink subband 310-b. In addition, the downlink BWP 320-b (which may be an active downlink BWP for the UE 115) fully overlaps with the first dedicated downlink subband 330-b and the second dedicated downlink subband 330-c, so the first dedicated downlink subband 330-b and second dedicated downlink subband 330-c includes resources of the overlapped portion of the downlink BWP 320-b and both the first cell downlink subband 305-c and the second cell downlink subband 305-d.

In some implementations, the configuration of the dedicated uplink and downlink subbands for SBFD may be based on one or more capabilities of the UE 115. For example, the UE 115 may support up to a threshold guard band size between the dedicated uplink subband 325-a and the dedicated downlink subbands (e.g., the first dedicated downlink subband 330-b and the second dedicated downlink subband 330-c). Additionally, or alternatively, the SBFD configuration may be based on one or more supported uplink and downlink subband sizes (e.g., the UE 115 may support one or more required sizes of the dedicated uplink subband 325-a, the first dedicated downlink subband 330-b, and the second dedicated downlink subband 330-c). In some examples, the supported uplink and downlink subband sizes may be configured to match an existing channel bandwidth of the UE, or may be configured to satisfy one or more size requirements (e.g., a minimum size or maximum size). In some aspects, the UE 115 may support capability signaling in which the UE 115 may transmit one or more messages that indicate one or more capabilities of the UE 115. For example, the UE 115 may signal a bitmap that is indicative of one or more sizes of uplink subbands, downlink subbands, or both, that the UE 115 supports.

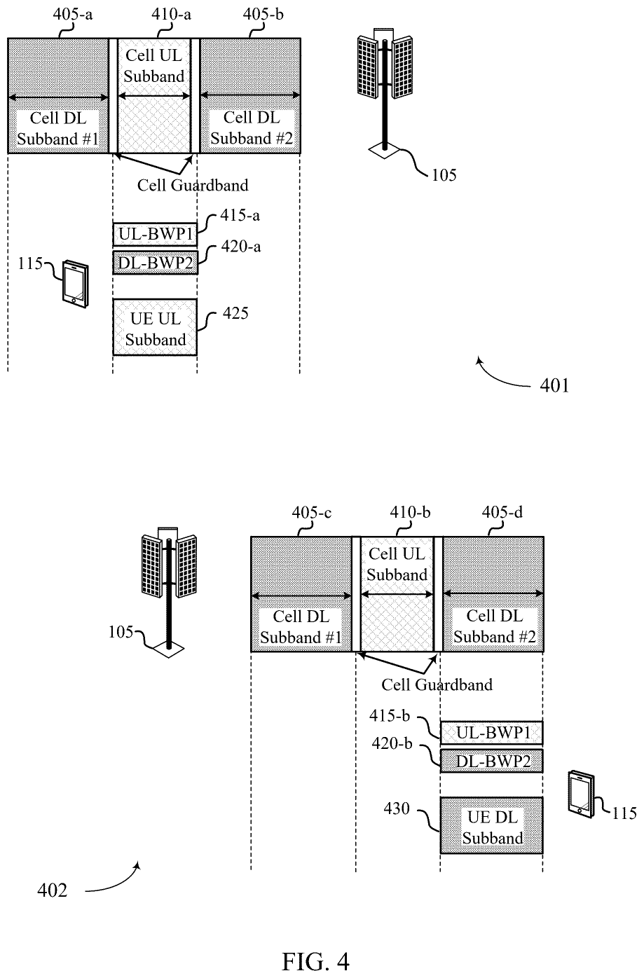

FIG. 4 shows an example of SBFD configuration 401 and SBFD configuration 402 that support subband configuration techniques for SBFD in accordance with one or more aspects of the present disclosure. For example, the SBFD configuration 401 and the SBFD configuration 402 may be implemented at or by aspects of wireless communications system 100 and wireless communications system 200, described with reference to FIGS. 1 and 2. For example, the SBFD configuration 401 and the SBFD configuration 402 may be configured by a network entity 105, and may be implemented by a UE 115, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some examples of the SBFD configuration 401 and the SBFD configuration 402, the network entity 105 may configure both uplink and downlink SBFD communications for each BWP pair supported by the UE 115. For example, the SBFD configuration 401 may illustrate an example BWP pair configuration including uplink BWP 415-a and downlink BWP 420-a, which may be configured for the UE 115 within (at least) a portion of the cell bandwidth supported by the network entity 105, including a first cell downlink subband 405-a, a cell uplink subband 410-a, and a second cell downlink subband 405-b, which may be separated from one another by a cell guard band.

In some examples, the UE 115 may operate within a UE-specific carrier bandwidth (which includes at least a portion of the cell bandwidth), and may receive one or more uplink and downlink SBFD configurations that configure different SBFD uplink and downlink subbands (e.g., dedicated uplink subband 425) that correspond to each uplink and downlink BWP pair within the channel bandwidth of the UE 115. For example, the UE 115 may have a dedicated subband, including dedicated uplink subband 425 that may span the same frequency as the uplink and downlink BWP pair. In some cases, the dedicated subband (e.g., dedicated uplink subband 425) may correspond to the set of cell-specific subbands. For example, the uplink BWP 415-a (which may be an active uplink BWP for the UE 115) may overlap with the cell uplink subband 410-a, and the corresponding SBFD uplink subband for the UE 115 (e.g., dedicated uplink subband 425) may include uplink resources located within the overlapped portion of the uplink BWP 415-a and the cell uplink subband 410-a. In addition, the downlink BWP 420-a (which may be an active downlink BWP for the UE 115) also may overlap with the cell uplink subband 410-a. In such examples, since the downlink BWP 420-a is non-overlapping with the first cell downlink subband 405-a or the second cell downlink subband 405-b, the UE 115 may lack a corresponding dedicated downlink subband for the uplink and downlink BWP pair. For example, the UE 115, for SBFD-configured symbols, may transmit uplink signals and uplink channels within its active uplink BWP (e.g., uplink BWP 415-a), and may not receive downlink signals or downlink channels from the network entity 105 within its active downlink BWP (e.g., downlink BWP 420-a). In such examples, the downlink BWP 420-a may be non-overlapping with the first cell downlink subband 405-a or the second cell downlink subband 405-b, or both.

The SBFD configuration 402 may illustrate an example BWP pair configuration including uplink BWP 415-b and downlink BWP 420-b, which may be configured for the UE 115 within (at least) a portion of the cell bandwidth supported by the network entity 105, including a first cell downlink subband 405-c, a cell uplink subband 410-b, and a second cell downlink subband 405-d, which may be separated from one another by a cell guard band.

In some examples, the UE 115 may operate within a UE-specific carrier bandwidth (which includes at least a portion of the cell bandwidth), and may receive one or more uplink and downlink SBFD configurations that configure different SBFD uplink and downlink subbands (e.g., dedicated downlink subband 430) that correspond to each uplink and downlink BWP pair within the channel bandwidth of the UE 115. For example, the UE 115 may have a dedicated subband, including dedicated downlink subband 430 that may span the same frequency as the uplink and downlink BWP pair. In some cases, the dedicated subband (e.g., dedicated downlink subband 430) may correspond to the set of cell-specific subbands. For example, the uplink BWP 415-b (which may be an active uplink BWP for the UE 115) may overlap with the second cell downlink subband 405-d, and may not overlap with the cell uplink subband 410-b. In such examples, the UE 115 may not have a corresponding uplink SBFD subband since the active uplink BWP does not overlap with the cell uplink subband 410-b. The downlink BWP 420-b may overlap with the second cell downlink subband 405-d, such that the corresponding SBFD downlink subband for the UE 115 (e.g., dedicated downlink subband 430) may include downlink resources located within the overlapped portion of the downlink BWP 420-b and the second cell downlink subband 405-d. For example, the UE 115, for SBFD-configured symbols, may receive downlink signals and downlink channels within its active downlink BWP (e.g., downlink BWP 420-b) and may not transmit uplink signals or uplink channels to the network entity 105 within its active uplink BWP (e.g., uplink BWP 415.b), due to an absence of a UE dedicated UL subband, due to the uplink BWP 415-b being non-overlapping with the cell uplink subband 410-b.

In some implementations, the configuration of the dedicated uplink and downlink subbands for SBFD may be based on one or more capabilities of the UE 115. For example, the SBFD configuration may be based on one or more supported uplink and downlink subband sizes (e.g., the UE 115 may support one or more required sizes of the dedicated uplink subband 425 and the dedicated downlink subband 430). In some examples, the supported uplink and downlink subband sizes may be configured to match an existing channel bandwidth of the UE 115, or may be configured to satisfy one or more size requirements (e.g., minimum size or maximum size). In some aspects, the UE 115 may support capability signaling in which the UE 115 may transmit one or more messages that indicate one or more capabilities of the UE 115. For example, the UE 115 may signal a bitmap that is indicative of one or more sizes of uplink subbands, downlink subbands, or both, that the UE 115 supports.

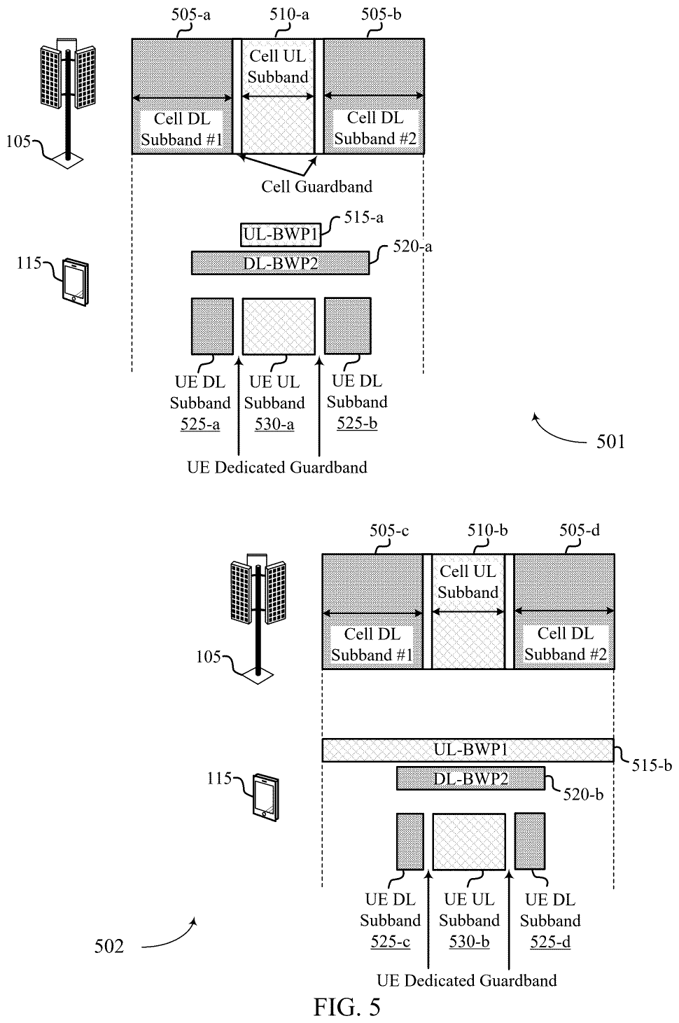

FIG. 5 shows an example of a SBFD configuration 501 and an SBFD configuration 502 that support subband configuration techniques for SBFD in accordance with one or more aspects of the present disclosure. For example, the SBFD configuration 501 and the SBFD configuration 502 may be implemented at or by aspects of wireless communications system 100 and wireless communications system 200, described with reference to FIGS. 1 and 2. For example, the SBFD configuration 501 and the SBFD configuration 502 may be configured by a network entity 105, and may be implemented by a UE 115, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some examples of the SBFD configuration 501 and the SBFD configuration 502, the network entity 105 may configure both uplink and downlink SBFD communications for each BWP pair supported by the UE 115. For example, the SBFD configuration 501 may illustrate an example BWP pair configuration including uplink BWP 515-a and downlink BWP 520-a, which may be configured for the UE 115 within (at least) a portion of the cell bandwidth supported by the network entity 105, including a first cell downlink subband 505-a, a cell uplink subband 510-a, and a second cell downlink subband 505-b, which may be separated from one another by a cell guard band. In some examples, the uplink BWP 515-a and the downlink BWP 520-a may span different bandwidths (e.g., the downlink BWP 520-a may be relatively larger than the uplink BWP 515-a to support increased downlink throughput, urgent traffic, or to support a relatively large quantity of downlink communications that exceeds a traffic threshold).

In some examples, the UE 115 may operate within a UE-specific carrier bandwidth (which includes at least a portion of the cell bandwidth), and may receive one or more uplink and downlink SBFD configurations that configure different SBFD uplink and downlink subbands (e.g., first dedicated downlink subband 525-a, second dedicated downlink subband 525-b, and dedicated uplink subband 530-a) that correspond to each uplink and downlink BWP pair within the channel bandwidth of the UE 115, and which are separated by a UE dedicated guard band. For example, the UE 115 may have dedicated subbands for SBFD, including the first dedicated downlink subband 525-a, the second dedicated downlink subband 525-b, and the dedicated uplink subband 530-a, that may span the same frequency as the uplink and downlink BWP pair. In some cases, the dedicated subbands (e.g., the first dedicated downlink subband 525-a, the second dedicated downlink subband 525-b, and the dedicated uplink subband 530-a) may correspond to the set of cell-specific subbands. For example, the uplink BWP 515-a (which may be an active uplink BWP for the UE 115) may overlap (at least partially) with the cell uplink subband 510-a, and the corresponding SBFD uplink subband for the UE 115 (e.g., dedicated uplink subband 530-a) may include uplink resources located within the overlapped portion of the uplink BWP 515-a and the cell uplink subband 510-a. In addition, the downlink BWP 520-a (which may be an active downlink BWP for the UE 115) also may overlap with the cell uplink subband 510-a, and may partially overlap with the first cell downlink subband 505-a and the second cell downlink subband 505-b. In such examples, the corresponding dedicated downlink subbands (e.g., first dedicated downlink subband 525-a and second dedicated downlink subband 525-b) may include downlink resources located within the overlapped portion of the downlink BWP 520-a, the first cell downlink subband 505-a, and the second cell downlink subband 505-b.

The SBFD configuration 402 may illustrate an example BWP pair configuration including uplink BWP 515-b and downlink BWP 520-b, which may be configured for the UE 115 within (at least) a portion of the cell bandwidth supported by the network entity 105, including a first cell downlink subband 505-c, a cell uplink subband 510-b, and a second cell downlink subband 505-d, which may be separated from one another by a cell guard band. In some examples, the uplink BWP 515-b and the downlink BWP 520-b may span different bandwidths (e.g., the uplink BWP 515-b may be relatively larger than the downlink BWP 520-b to support increased uplink throughput, urgent traffic, or to support a relatively large quantity of uplink communications by the UE 115).

In some examples, the UE 115 may operate within a UE-specific carrier bandwidth (which includes at least a portion of the cell bandwidth), and may receive one or more uplink and downlink SBFD configurations that configure different SBFD uplink and downlink subbands (e.g., first dedicated downlink subband 525-c, second dedicated downlink subband 525-d, and dedicated uplink subband 530-b) that correspond to each uplink and downlink BWP pair within the channel bandwidth of the UE 115. For example, the UE 115 may have dedicated subbands for SBFD, including the first dedicated downlink subband 525-c, the second dedicated downlink subband 525-d, and the dedicated uplink subband 530-b, that may span the same frequency as the uplink and downlink BWP pair. In some cases, the dedicated subbands (e.g., the first dedicated downlink subband 525-c, the second dedicated downlink subband 525-d, and the dedicated uplink subband 530-b) may correspond to the set of cell-specific subbands. For example, the uplink BWP 515-b (which may be an active uplink BWP for the UE 115) may overlap with the cell uplink subband 510-b, and the corresponding SBFD uplink subband for the UE 115 (e.g., dedicated uplink subband 530-b) may include uplink resources located within the overlapped portion of the uplink BWP 515-b and the cell uplink subband 510-b. In addition, the downlink BWP 520-b (which may be an active downlink BWP for the UE 115) also may overlap with the cell uplink subband 510-b, and may partially overlap with the first cell downlink subband 505-c and the second cell downlink subband 505-d. In such examples, the corresponding dedicated downlink subbands (e.g., first dedicated downlink subband 525-c and second dedicated downlink subband 525-d) may include downlink resources located within the overlapped portion of the downlink BWP 520-b, the first cell downlink subband 505-c, and the second cell downlink subband 505-d.

In some implementations, the configuration of the dedicated uplink and downlink subbands for SBFD may be based on one or more capabilities of the UE 115. For example, the UE 115 may support up to a threshold guard band size between the dedicated uplink subband and the dedicated downlink subbands. Additionally, or alternatively, the SBFD configuration may be based on one or more supported uplink and downlink subband sizes (e.g., the UE 115 may support one or more required sizes of the dedicated uplink subbands, the first dedicated downlink subband, and the second dedicated downlink subband). In some examples, the supported uplink and downlink subband sizes may be configured to match an existing channel bandwidth of the UE 115, or may be configured to satisfy one or more size requirements (e.g., minimum size or maximum size). In some aspects, the UE 115 may support capability signaling in which the UE 115 may transmit one or more messages that indicate one or more capabilities of the UE 115. For example, the UE 115 may signal a bitmap that is indicative of one or more sizes of uplink subbands, downlink subbands, or both, that the UE 115 supports.

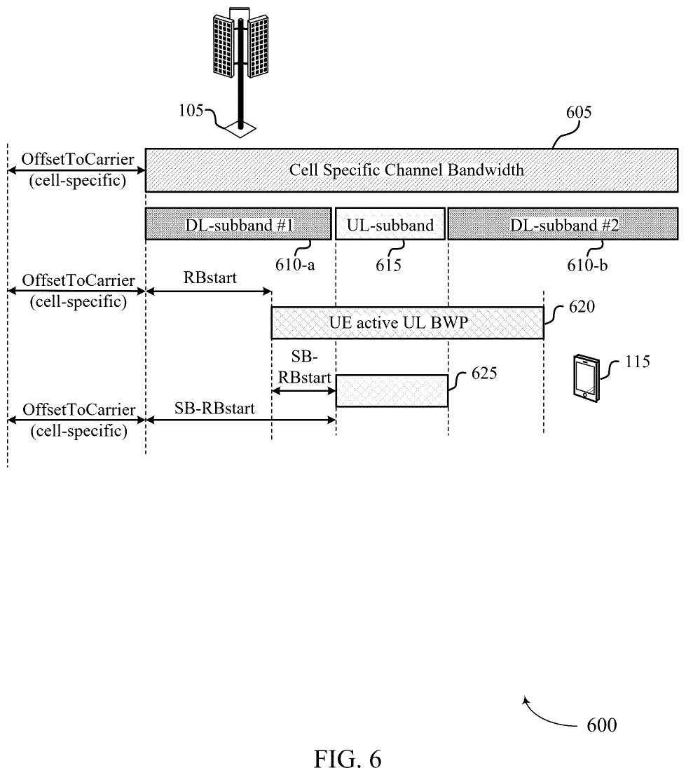

FIG. 6 shows an example of an SBFD configuration 600 that supports subband configuration techniques for SBFD in accordance with one or more aspects of the present disclosure. For example, the SBFD configuration 600 may be implemented at or by aspects of wireless communications system 100 and wireless communications system 200, described with reference to FIGS. 1 and 2. For example, the SBFD configuration 600 may be configured by a network entity, and may be implemented by a UE, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some aspects, the network entity 105 may support communications on cell-specific channel bandwidth 605, which may include at least a portion of a frequency band of a carrier. In some examples, a relative frequency location of the cell-specific channel bandwidth 605 may be indicated with respect to a carrier offset (e.g., a cell-specific offset to carrier). The network entity 105 may perform communications using different frequencies and communications resources located at the cell-specific channel bandwidth 605. In some cases, the cell-specific channel bandwidth 605 may be segmented into a quantity of uplink and downlink subbands. For example, the cell-specific channel bandwidth 605 may include a first downlink subband 610-a, a second downlink subband 610-b, and an uplink subband 615. The network entity 105 may obtain or receive uplink communications using the uplink subband 615 (or may allocate resources for various uplink communications on the uplink subband 615), and may perform downlink communications using the first downlink subband 610-a and the second downlink subband 610-b (or may allocate resources for various downlink communications on the first downlink subband 610-a and the second downlink subband 610-b).

In some implementations, the UE 115 may be allocated one or more active BWPs using at least a portion of the cell-specific channel bandwidth 605. For example, the UE 115 may be allocated an active uplink BWP 620. In such examples, the network entity 105 may configure an uplink and downlink SBFD configuration for each BWP (or BWP pair) allocated to the UE 115. For example, the SBFD configuration may indicate an uplink subband 625 for the UE 115 to use for SBFD communications. In some other examples, the UE 115 may be allocated one or more downlink BWPs, and corresponding downlink subbands, such that the description of SBFD configuration 600 is not limited to uplink BWPs and corresponding uplink subbands.

In some aspects, the UE 115 may identify the subband frequency location (e.g., a frequency location of the uplink subband 625) based on a resource indication value (RIV) that indicates a “start” resource block (e.g., a resource block where the subband begins) and number associated with the resource block. In some examples, the start resource block may be determined using the same subcarrier spacing of the active uplink BWP 620. In some implementations, the start resource block of the uplink subband 625 may be determined with respect the lowest (e.g., first) physical resource block (PRB) of the carrier. For example, the UE 115 may determine (or the SBFD configuration may indicate) the common resource block where the uplink subband 625 starts (N_{SB}^{start}), with respect to the first resource block of the carrier, CRB0, using:

$${N}_{SB}^{start} = {O}_{c a r r i e r} + Subband - {Rb}_{start} ,$$

where O_{carrier} is the offset to the carrier (cell-specific) and the Subband-Rbₛₜₐᵣₜ is the offset from the end of the offset to the carrier (cell-specific) to the beginning of the uplink subband 625. In such examples, the RIV may be determined assuming N_{subband}^{size}=275 resource blocks.

In some other examples, the UE 115 may determine the start resource block of the uplink subband 625 with respect the lowest (e.g., first) PRB of the active uplink BWP 620. The RIV may be determined based on the actual size of the active uplink BWP 620, which may reduce overhead associated with the RIV calculation. For example, the UE 115 may determine the common resource block where the uplink subband starts (N_{SB}^{start}) with respect to the first resource block of the carrier, CRB0, using:

$${N}_{SB}^{start} = {O}_{c a r r i e r} + RB - start ( BWP ) + Subband - {Rb}_{start} ,$$

where O_{carrier} is the offset to the carrier (cell-specific), RB-start (BWP) is the offset from end of the offset of the carrier (cell-specific) to the beginning of the active uplink BWP 620, and the Subband-Rbₛₜₐᵣₜ is the offset from the beginning of the active uplink BWP 620 to the beginning of the uplink subband 625.

In some other examples, the network entity 105 may configure the uplink and downlink SBFD configuration for each BWP pair, where each of the uplink and downlink subbands represent corresponding virtual uplink and downlink BWPs in one or more SBFD symbols. For example, the uplink and downlink subbands may include similar or identical frequency resources, size, or both, as the corresponding uplink and downlink BWPs, or may be associated with the corresponding uplink and downlink BWPs by one or more mappings. In some aspects, the association between the uplink and downlink subbands and the corresponding virtual uplink and downlink BWPs may enable efficient allocation for uplink frequency resources in terms of frequency domain resource allocation (FDRA), such as type 0/1 FDRA, intra-slot and inter-slot frequency hopping, among other frequency resource allocation techniques, since the frequency resource allocation may be the same for the uplink and downlink subbands as for one or more uplink and downlink BWPs.

In some examples, the network entity 105, the UE 115, or both, may determine a resource block group (RBG) size of a frequency allocation (e.g., allocation type 0, bitmap-based allocation) based on the uplink and downlink subband size in SBFD symbols (e.g., N_{BWP}^{size}=N_{subband}^{size} and). In such examples, the starting resource block of the resource allocation may be the first resource block of the uplink subband, or the downlink subband, given by N_{BWP}^{start}=N_{subband}^{start}. In such examples, the active uplink BWP 620 may be represented as a virtual BWP that has the same size and starting resource block of the uplink subband 625.

In some other examples, the network entity 105, the UE 115, or both, may determine a resource block group (RBG) size of a frequency allocation (e.g., allocation type 1) using a RIV-based allocation type: In such examples, the starting resource block may correspond to a starting resource block in reference to the lowest (e.g., first) downlink or uplink subband, where N_{BWP}^{size}=N_{subband}^{size}.

In some other examples, the resource allocation may be configured with a frequency hopping-based approach, where the starting resource block corresponds to the starting resource block in reference to the lowest (e.g., first) resource block of the uplink subband, where the resource block offset is an SBFD-specific offset or is determined based on the subband size. For example, for intra-slot frequency hopping, the starting resource block may be determined using:

$${RB}_{start} = \{ \begin{matrix}\begin{matrix}{RB}_{start} , & i = 0\end{matrix} \\ ( {RB}_{start} + {RB}_{offset} ) mod {N}_{SB}^{size} , i = 1\end{matrix} ,$$

and for inter-slot frequency hopping, the starting resource block may be determined using:

$${RB}_{start} = \{ \begin{matrix}\begin{matrix}{RB}_{start} , & {n}_{s}^{μ} = 0\end{matrix} \\ ( {RB}_{start} + {RB}_{offset} ) mod {N}_{SB}^{size} , {n}_{s}^{μ} = 1\end{matrix} .$$

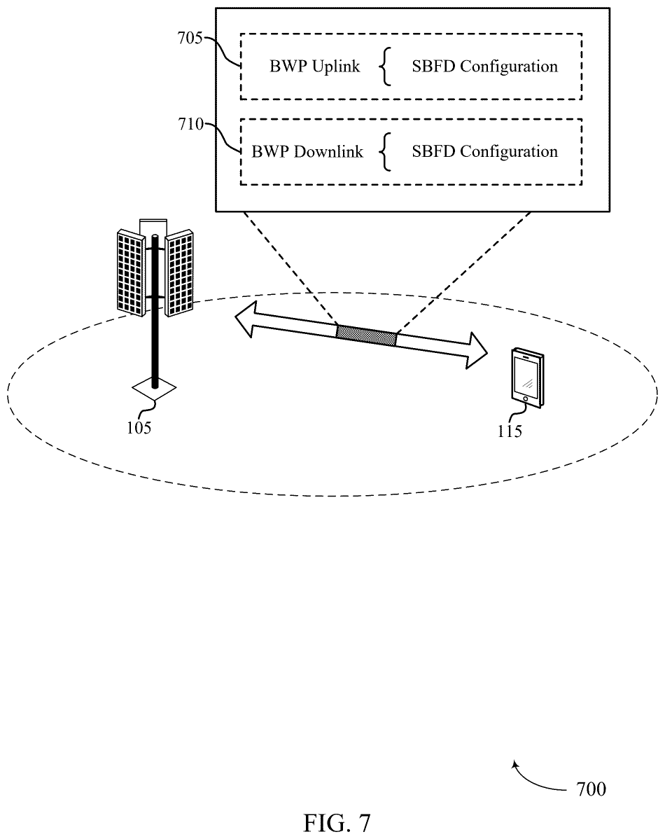

FIG. 7 shows an example of a wireless communications system 700 that supports subband configuration techniques for SBFD in accordance with one or more aspects of the present disclosure. For example, the wireless communications system 700 may illustrate communications between a network entity 105 and a UE 115, each of which may be examples of corresponding network entities 105 and UEs 115 as described with reference to FIGS. 1 and 2. In some examples, the UE 115 and network entity 105 may support SBFD communications including uplink and downlink signaling in an allocated frequency band.

In aspects, the network entity 105 may signal or otherwise indicate an uplink and downlink SBFD configuration as a single cell-common configuration, or using a per-BWP configuration. For example, to support efficient SBFD resource allocation and communication, the network entity 105 may configure an uplink and downlink SBFD configuration for each uplink and downlink BWP pair (including an uplink BWP and a downlink BWP) configured for the UE 115. In some implementations, the uplink and downlink SBFD configuration may be indicative of a resource allocation associated with SBFD communications for the UE 115. For example, each uplink BWP may correspond to a dedicated uplink subband for SBFD communications, and each downlink BWP may correspond to a dedicated downlink subband for SBFD communications.

In some implementations, the network entity 105 may configure SBFD-dedicated uplink and downlink signals, and the associated channels that support the UE-dedicated uplink and downlink subbands. In some examples, the SBFD configuration may be included in a first information element 705 for the uplink BWP (e.g., BWP-Uplink), in a second information element 710 for the downlink BWP (e.g., BWP-Downlink), or both. For example, each of the BWP-Uplink and BWP-Downlink may include an SBFD configuration field and a SBFD configuration identifier (e.g., SBFD-Configuration, SBFD-Configuration-id) that may configure the dedicated uplink and downlink subbands for the uplink and downlink BWPs. Additionally, or alternatively, the SBFD configuration may be different uplink and downlink SBFD configurations such that each of the BWP-Uplink and BWP-Downlink may include a corresponding uplink or downlink SBFD configuration field and a SBFD configuration identifier (e.g., UL-SBFD-Configuration, DL-SBFD-Configuration, SBFD-Configuration-id).

For example, a BWP-Uplink information element may include:

| | |
|---|---|
| BWP-Uplink ::= | SEQUENCE { |
| bwp-Id | BWP-Id, |
| bwp-Common | BWP-UplinkCommon |
| bwp-Dedicated | BWP-UplinkDedicated |
| SBFD-Configuration | SBFD-configuration_id |

...
},

where the SBFD-Configuration and the SBFD-configuration_id indicate the SBFD configuration for one or more dedicated uplink subbands. Additionally, or alternatively, a downlink a BWP-Downlink information element may include:

| | |
|---|---|
| BWP-Downlink ::= | SEQUENCE { |
| bwp-Id | BWP-Id, |
| bwp-Common | BWP-DownlinkCommon |
| bwp-Dedicated | BWP-WownlinkDedicated |
| SBFD-Configuration | SBFD-configuration_id |

...
}

where the SBFD-Configuration and the SBFD-configuration_id indicate the SBFD configuration for one or more dedicated downlink subbands.

The SBFD configuration may include various parameters, including uplink and downlink subband locations, subcarrier spacing information, time locations, semi-persistent scheduling configurations, uplink channel configurations, configured grant configurations, sounding reference signal configurations, among other parameters. For example, an SBFD-Configuration field may include:

| SBFD-configuration ::= | SEQUENCE { |
|---|---|
| SBFD-configuration_id | SBs-Id, |
| UL-subband-locationAndBW (RIV) | |
| DL-subband_1-locationAndBW (RIV) | |
| DL-subband_2-locationAndBW (RIV) | |
| Subband-subbcarrierSpacing | |
| SBFD_time_locations | |
| sps-Config | SetupRelease { SPS-Config } |
| pucch-Config | SetupRelease { PUCCH-Config } |
| pusch-Config | SetupRelease { PUSCH-Config } |
| configuredGrantConfig | SetupRelease { ConfiguredGrantConfig } |
| srs-Config | SetupRelease { SRS-Config } |

}

In some other examples, a BWP-Uplink information element may include a specific uplink SBFD configuration (UL-SBFD-Configuration), and may include:

| | |
|---|---|
| BWP-Uplink ::= | SEQUENCE { |
| bwp-Id | BWP-Id, |
| bwp-Common | BWP-UplinkCommon |
| bwp-Dedicated | BWP-UplinkDedicated |
| UL-SBFD-Configuration | SBFD-configuration_id |

...
},

where the UL-SBFD-Configuration and the SBFD-configuration_id indicate a dedicated uplink SBFD configuration for one or more dedicated uplink subbands. In such examples, the UL-SBFD-Configuration may include various parameters, including uplink subband locations, subcarrier spacing information, time locations, semi-persistent scheduling configurations, uplink channel configurations, configured grant configurations, sounding reference signal configurations, among other parameters. For example, an UL-SBFD-Configuration field may include:

| | |
|---|---|
| UL-SBFD-configuration::= | SEQUENCE { |
| UL-SBFD-configuration_id | SBs-Id, |
| UL-subband-locationAndBW | (RIV) |

```
    Subband-subbcarrierSpacing
    SBFD_time_locations
```

| | |
|---|---|
| pucch-Config | SetupRelease { PUCCH-Config } |
| pusch-Config | SetupRelease { PUSCH-Config } |
| configuredGrantConfig | SetupRelease { ConfiguredGrantConfig } |
| srs-Config | SetupRelease { SRS-Config } |

}.

Additionally, or alternatively, a downlink a BWP-Downlink information element may include a specific downlink SBFD configuration (DL-SBFD-Configuration), and may include:

| | |
|---|---|
| BWP-Downlink ::= | SEQUENCE { |
| bwp-Id | BWP-Id, |
| bwp-Common | BWP-DownlinkCommon |
| bwp-Dedicated | BWP-WownlinkDedicated |
| DL-SBFD-Configuration | SBFD-configuration_id |

...
}

where the DL-SBFD-Configuration and the SBFD-configuration_id indicate a dedicated downlink SBFD configuration for one or more dedicated downlink subbands. In such examples, the DL-SBFD-Configuration may include various parameters, including downlink subband locations, subcarrier spacing information, time locations, semi-persistent scheduling configurations, downlink channel configurations, configured grant configurations, sounding reference signal configurations, among other parameters. For example, a DL-SBFD-Configuration field may include:

| DL-SBFD-configuration::= SEQUENCE { | |
|---|---|
| SBFD-configuration_id SBs-Id, | |
| DL-subband_1-locationAndBW (RIV) | |
| DL-subband_2-locationAndBW (RIV) | |
| Subband-subbcarrierSpacing | |
| sps-Config | SetupRelease { SPS-Config } |
| pdcch-Config | SetupRelease { PDCCH-Config } |
| pdsch-Config | SetupRelease { PDSCH-Config } |

}.

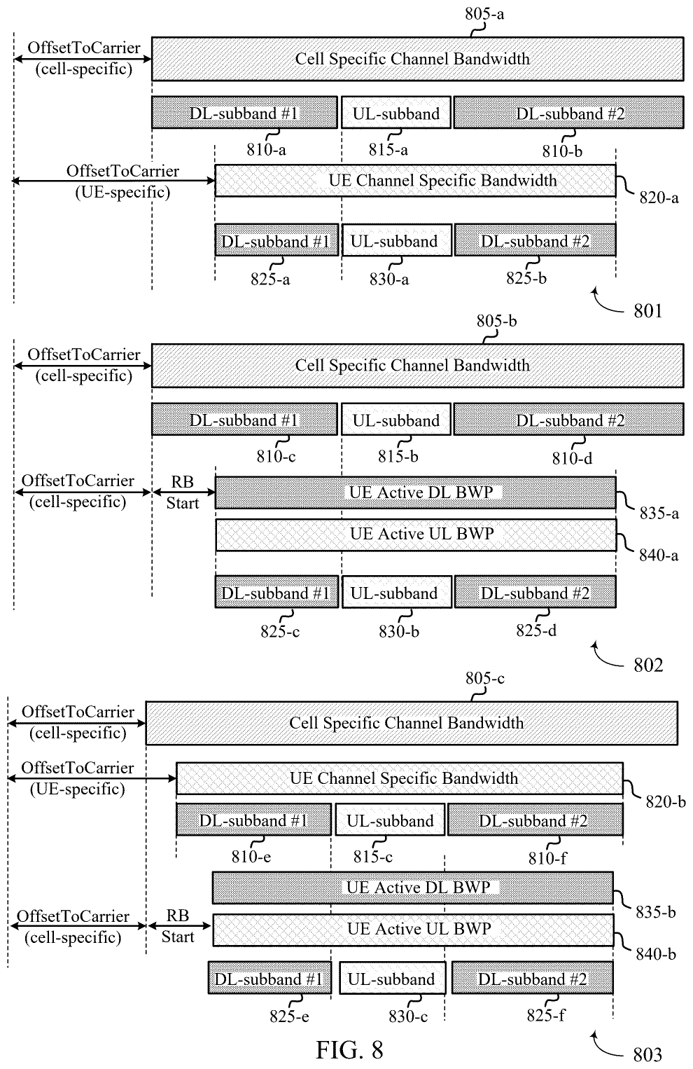

FIG. 8 shows an example of a SBFD configuration 801, a SBFD configuration 802, and a SBFD configuration 803 that support subband configuration techniques for SBFD in accordance with one or more aspects of the present disclosure. For example, the SBFD configuration 801, SBFD configuration 802, and SBFD configuration 803 may be implemented at or by aspects of wireless communications system 100 and wireless communications system 200, described with reference to FIGS. 1 and 2. For example, the SBFD configuration 801, SBFD configuration 802, and SBFD configuration 803 may be configured by a network entity, and may be implemented by a UE, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some implementations, a network entity may configure a cell-common uplink and downlink SBFD configuration, where resources for the uplink and downlink subbands for SBFD communications (e.g., frequency locations of the uplink and downlink subbands) may be defined within a common resource block grid of a cell. In SBFD configuration 801, for example, a network entity may support communications on cell-specific channel bandwidth 805-a, which may include at least a portion of a frequency band of a carrier. In some examples, a relative frequency location of the cell-specific channel bandwidth 805-a may be indicated with respect to a carrier offset (e.g., a cell-specific offset to carrier). The network entity may perform communications using different frequencies and communications resources located at the cell-specific channel bandwidth 805-a. In some cases, the cell-specific channel bandwidth 805-a may be segmented into a quantity of uplink and downlink subbands. For example, the cell-specific channel bandwidth 805-a may include a first downlink subband 810-a, a second downlink subband 810-b, and an uplink subband 815-a. The network entity may obtain uplink communications using the uplink subband 815-a (or may allocate resources for various uplink communications on the uplink subband 815-a), and may output downlink communications using the first downlink subband 810-a and the second downlink subband 810-b (or may allocate resources for various downlink communications on the first downlink subband 810-a and the second downlink subband 810-b).

In some implementations, a UE may be allocated a UE channel specific bandwidth 820-a, which may include at least a portion of the cell-specific channel bandwidth 805-a. In such examples, the network entity may configure one or more cell-specific uplink and downlink SBFD configurations, where the SBFD configuration may be specific to the cell-specific channel bandwidth 805-a, or the UE channel specific bandwidth 820-a. For example, the SBFD configuration may indicate a first dedicated downlink subband 825-a, a second dedicated downlink subband 825-b, and a dedicated uplink subband 830-a for the UE 115 to use for SBFD communications. In cases where the SBFD configuration is associated with the cell-specific channel bandwidth 805-a, the dedicated uplink and downlink subbands may be indicated within the common resource blocks of the cell-specific channel bandwidth (e.g., the cell-specific channel bandwidth 805-a). Additionally, or alternatively, in cases where the SBFD configuration is associated with the UE channel specific bandwidth 820-a, the dedicated uplink and downlink subbands may be provided within the common resource blocks of the UE-dedicated channel bandwidth (e.g., the UE channel specific bandwidth 820-a).

In SBFD configuration 802, the network entity may support communications on cell-specific channel bandwidth 805-b, which may include at least a portion of a frequency band of a carrier. In some examples, a relative frequency location of the cell-specific channel bandwidth 805-b may be indicated with respect to a carrier offset (e.g., a cell-specific offset to carrier). The network entity may perform communications using different frequencies and communications resources located at the cell-specific channel bandwidth 805-b. In some cases, the cell-specific channel bandwidth 805-b may be segmented into a quantity of uplink and downlink subbands. For example, the cell-specific channel bandwidth 805-b may include a first downlink subband 810-c, a second downlink subband 810-d, and an uplink subband 815-b. The network entity may obtain uplink communications using the uplink subband 815-b (or may allocate resources for various uplink communications on the uplink subband 815-b), and may perform or output downlink communications using the first downlink subband 810-c and the second downlink subband 810-d (or may allocate resources for various downlink communications on the first downlink subband 810-c and the second downlink subband 810-d).

In some implementations, a UE may be allocated one or more active uplink and downlink BWPs (e.g., active downlink BWP 835-a and active uplink BWP 840-a), which may be allocated to the UE using at least a portion of the cell-specific channel bandwidth 805-b. In such examples, the network entity may configure one or more cell-common uplink and downlink SBFD configurations, where the UE may implicitly determine one or more usable or available resources for uplink and downlink communications (e.g., SBFD communications) per the active downlink BWP 835-a and active uplink BWP 840-a, respectively. In some examples, the UE may determine the SBFD configuration for uplink and downlink communications based on the overlapping frequency resources (e.g., PRBs) between the downlink and uplink SBs (e.g., first dedicated downlink subband 825-c, second dedicated downlink subband 825-d, and dedicated uplink subband 830-b) and the active downlink and uplink BWPs. In some examples, The UE may receive communications in downlink frequency resources of the first dedicated downlink subband 825-c, the second dedicated downlink subband 825-d, or both, which may be within the active downlink BWP 835-a. Additionally, or alternatively, the UE may transmit communications in uplink frequency resources of the dedicated uplink subband 830-b which may be within the active uplink BWP 840-a.

In SBFD configuration 803, the network entity may support communications on cell-specific channel bandwidth 805-c, which may include at least a portion of a frequency band of a carrier. In some examples, a relative frequency location of the cell-specific channel bandwidth 805-c may be indicated with respect to a carrier offset (e.g., a cell-specific offset to carrier). The network entity may perform communications using different frequencies and communications resources located at the cell-specific channel bandwidth 805-c. In some cases, the cell-specific channel bandwidth 805-c may be segmented into a UE channel specific bandwidth 820-b, which may be further segmented into a quantity of uplink and downlink subbands. For example, the UE channel specific bandwidth 820-b may include a first downlink subband 810-e, a second downlink subband 810-f, and an uplink subband 815-c. The UE may perform uplink communications using the uplink subband 815-c, and may receive downlink communications using the first downlink subband 810-e and the second downlink subband 810-f.

In some implementations, a UE may be allocated one or more active uplink and downlink BWPs (e.g., active downlink BWP 835-b and active uplink BWP 840-b), which may be allocated to the UE using at least a portion of the UE channel specific bandwidth 820-b. In such examples, the network entity may configure one or more cell-common uplink and downlink SBFD configurations, where the UE may implicitly determine one or more usable or available resources for uplink and downlink communications (e.g., SBFD communications) per the active downlink BWP 835-b and active uplink BWP 840-b, respectively. In some examples, the UE may determine the SBFD configuration for uplink and downlink communications based on the overlapping frequency resources (e.g., PRBs) between the downlink and uplink subbands (e.g., first dedicated downlink subband 825-e, second dedicated downlink subband 825-f, and dedicated uplink subband 830-c) and the active downlink and uplink BWPs. In some examples, The UE may receive communications in downlink frequency resources of the first dedicated downlink subband 825-e, the second dedicated downlink subband 825-f, or both, which may be within the active downlink BWP 835-b. Additionally, or alternatively, the UE may transmit communications in uplink frequency resources of the dedicated uplink subband 830-c which may be within the active uplink BWP 840-b.

In some implementations, a network entity may indicate one or more SBFD time patterns or time resources for a UE that is in a connected (e.g., RRC connected) state. For example, the network entity may indicate the one or more SBFD time patterns or time resources in a UE-dedicated cell common configuration (e.g., via a ServingCellConfig information element). For example, the UE-dedicated cell common configuration may be used to configure (e.g., add or modify) the UE with a serving cell, and may indicate a set of cell-specific parameters including the SBFD time patterns or resources. In some aspects, the UE-dedicated cell common configuration may include aspects of a downlink-uplink time division duplexing configuration, where the uplink and downlink subbands may have a subcarrier spacing that is different from a subcarrier spacing of a corresponding BWP.

In some other examples, the network entity may indicate the one or more SBFD time patterns or time resources in a UE-dedicated configuration per each uplink and downlink BWP configuration using the same BWP subcarrier spacing. In some other examples, the network entity may indicate the one or more SBFD time patterns or time resources in a cell common configuration broadcasted via a system information message (e.g., a SIB message). For example, the SBFD time patterns or time resources may be indicated via a common serving cell configuration (e.g., via the ServingCellConfigCommon information element), with subcarrier spacing that is the same as the subcarrier spacing associated with TDD-DL-UL common. In such examples, the UE may be in an active state, an idle state, or an inactive state. Additionally, or alternatively, the SBFD pattern periodicity may be calculated or otherwise determined based on the TDD-DL-UL periodicity, or the SBFD pattern periodicity may be explicitly indicated or configured by the network entity.

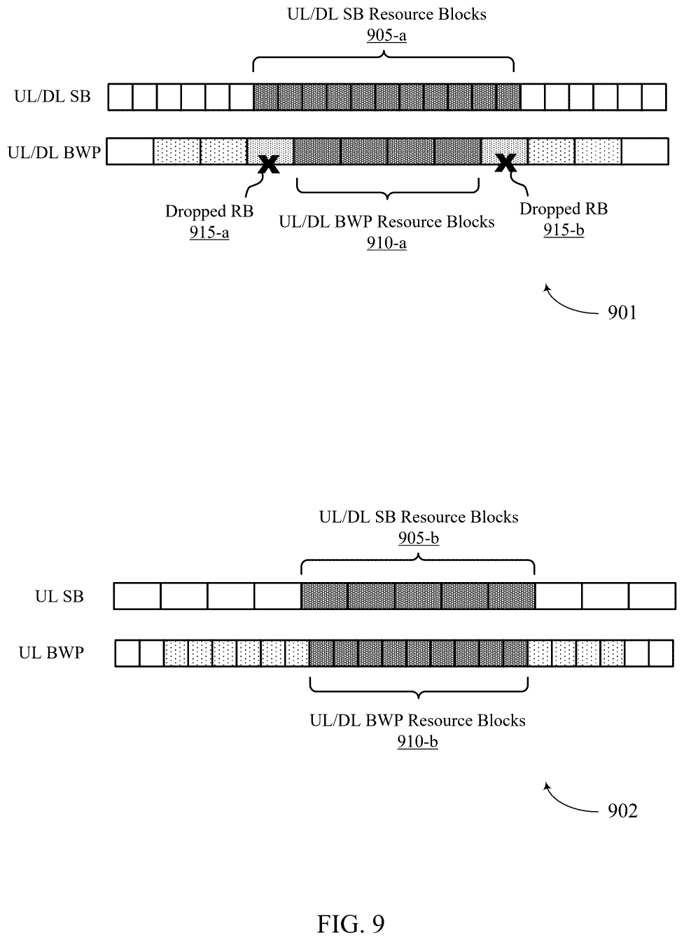

FIG. 9 shows an example of a SBFD configuration 901 and SBFD configuration 902 that support subband configuration techniques for SBFD in accordance with one or more aspects of the present disclosure. For example, the SBFD configuration 901 and SBFD configuration 902 may be implemented at or by aspects of wireless communications system 100 and wireless communications system 200, described with reference to FIGS. 1 and 2. For example, the SBFD configuration 901 and SBFD configuration 902 may be configured by a network entity, and may be implemented by a UE, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some implementations, a network entity may configure SBFD configurations per allocated BWP of a UE. For example, the UE may use a set of designated uplink subbands, downlink subbands, or both, that correspond to resources within an active uplink or downlink BWP configured for the UE. In some cases, however, a subcarrier spacing of the downlink BPW, the uplink BWP, or both, may be different from the subcarrier spacing of the dedicated uplink subband, the dedicated downlink subband, or both, as illustrated in SBFD configuration 901. For example, a set of uplink or downlink resource blocks 905-a of an uplink or downlink subband may be configured for uplink or downlink communications. In addition, a corresponding set of uplink or downlink resource blocks 910-a of a corresponding uplink or downlink BWP may also be configured. In some aspects, one or more resource blocks of the uplink or downlink BWP may extend past the allocated resource blocks of the uplink or downlink subband. In such examples where the subcarrier spacing of the uplink or downlink BWP is greater than the subcarrier spacing of the designated uplink or downlink, the edge resource blocks may be dropped (e.g., dropped RB 915-a and dropped RB 915-b).

In some other cases, a subcarrier spacing of the downlink BPW, the uplink BWP, or both, may be smaller than the subcarrier spacing of the dedicated uplink subband, the dedicated downlink subband, or both, as illustrated in SBFD configuration 902. For example, a set of uplink or downlink resource blocks 905-b of an uplink or downlink subband may be configured for uplink or downlink communications. In addition, a corresponding set of uplink or downlink resource blocks 910-b of a corresponding uplink or downlink BWP may also be configured. In some aspects, the resource blocks of the uplink or downlink BWP may be included in the allocated resource blocks of the uplink or downlink subband. In such examples where the subcarrier spacing of the uplink or downlink BWP is smaller than the subcarrier spacing of the designated uplink or downlink, the UE may refrain from dropping resource blocks.

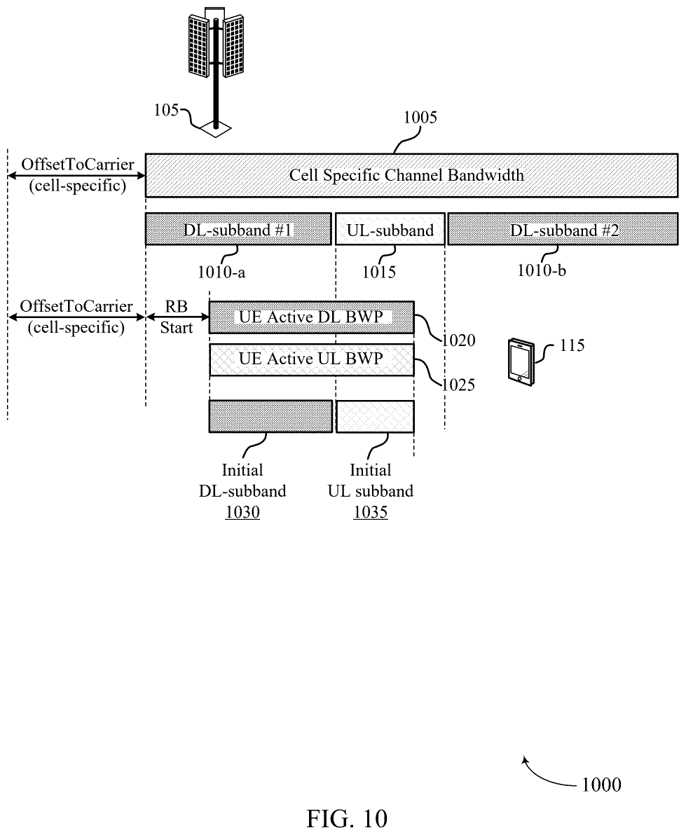

FIG. 10 shows an example of a SBFD configuration 1000 that supports subband configuration techniques for SBFD in accordance with one or more aspects of the present disclosure. For example, the SBFD configuration 1000 may be implemented at or by aspects of wireless communications system 100 and wireless communications system 200, described with reference to FIGS. 1 and 2. For example, the SBFD configuration 1000 may be configured by a network entity, and may be implemented by a UE, each of which may be examples of corresponding network entities 105 and UEs 115 as described with reference to FIGS. 1 and 2. In some examples, the UE 115 and network entity 105 may support SBFD communications including simultaneous uplink and downlink signaling in an allocated frequency band.

In some aspects, the network entity 105 may support communications on cell-specific channel bandwidth 1005, which may include at least a portion of a frequency band of a carrier. In some examples, a relative frequency location of the cell-specific channel bandwidth 1005 may be indicated with respect to a carrier offset (e.g., a cell-specific offset to carrier). The network entity 105 may perform communications using different frequencies and communications resources located at the cell-specific channel bandwidth 1005. In some cases, the cell-specific channel bandwidth 1005 may be segmented into a quantity of uplink and downlink subbands. For example, the cell-specific channel bandwidth 1005 may include a first downlink subband 1010-a, a second downlink subband 1010-b, and an uplink subband 1015. The network entity 105 may obtain uplink communications using the uplink subband 1015 (or may allocate resources for various uplink communications on the uplink subband 1015), and may perform or output downlink communications using the first downlink subband 1010-a and the second downlink subband 1010-b (or may allocate resources for various downlink communications on the first downlink subband 1010-a and the second downlink subband 1010-b).

In some implementations, the UE 115 may be allocated one or more active BWPs using at least a portion of the cell-specific channel bandwidth 1005. For example, the UE 115 may be allocated an active downlink BWP 1020 and an active uplink BWP 1025. In such examples, the network entity 105 may configure an uplink and downlink SBFD configuration for each BWP (or BWP pair) allocated to the UE 115. In some examples, the UE channel bandwidth may be configured for the UE 115 after RRC connection, where during an initial access procedure the UE 115 identifies the serving cell channel bandwidth and location, in addition to one or more initial BWP locations. In some cases, however, the UE 115 may be operating in an idle or inactive state, and the network entity 105 may use broadcast signaling (among other techniques) to configure the UE 115 with uplink and downlink subband configurations. For example, the network entity 105 may transmit one or more system information blocks (e.g., SIB1) that includes the time and frequency configurations of the dedicated uplink and downlink subbands. In some examples, the uplink and downlink subband locations may be configured or defined per the initial uplink and downlink BWP cell-specific channel bandwidth (e.g., the downlink and uplink subbands may be include within the common resource blocks of the cell-specific channel bandwidth). Additionally, or alternatively, configurations for the initial downlink subband 1030 and the initial uplink subband 1035 may be indicated per the serving cell bandwidth (e.g., within the resource blocks of the initial channel bandwidth).

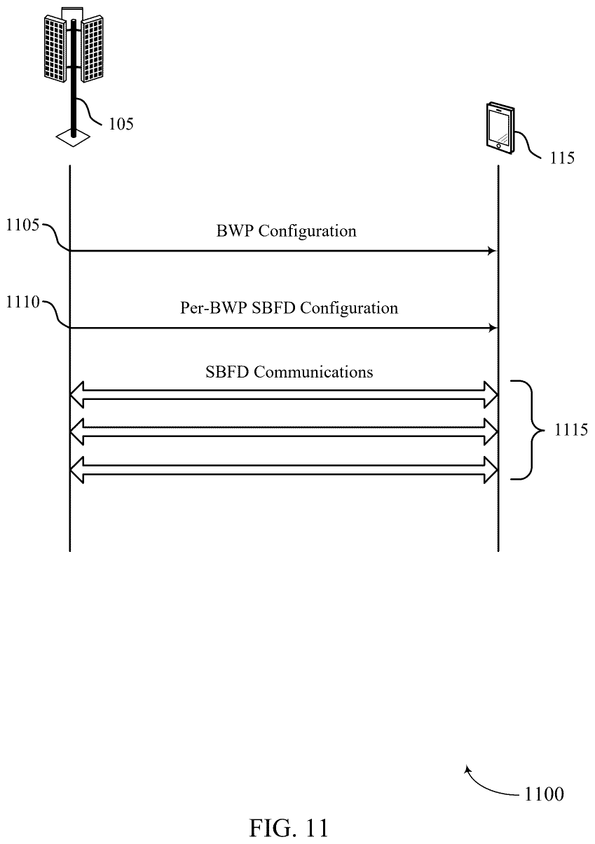

FIG. 11 shows an example of a process flow 1100 that supports subband configuration techniques for SBFD in accordance with one or more aspects of the present disclosure. The process flow 1100 may implement or be implemented by aspects of the wireless communications system 100 and the wireless communications system 200. The process flow 1100 may include a network entity 105 and a UE 115, each of which may be examples of network entities and UEs described herein. In the following description of process flow 1100, the operations may be performed in a different order than the order shown, or other operations may be added or removed from the process flow 1100. For example, some operations may also be left out of process flow 1100, may be performed in different orders or at different times, or other operations may be added to process flow 1100. Although communications of the process flow 1100 are shown occurring between a network entity 105 and a UE 115, some aspects of some operations may also be performed by one or more other wireless devices, network devices, or network functions.

At 1105, the UE 115 may receive first information that is indicative of one or more BWP pairs configured for the UE 115, where each BWP pair of the one or more BWP pairs includes a respective uplink BWP and a respective downlink BWP that at least partially occupy a channel bandwidth of the UE 115.

At 1110, the UE 115 may receive second information that is indicative of a SBFD configuration for each of the one or more BWP pairs, where the SBFD configuration indicates an uplink subband, a downlink subband or both, that corresponds to each of the one or more BWP pairs, which may include one or more active BWPs. In some examples, the UE 115 may transmit one or more UE capabilities via capability signaling prior to receiving the second information. In such examples, the UE 115 may receive the second information indicative of the SBFD configuration, where the SBFD configuration is based on (or configured in accordance with) the one or more UE capabilities. In some aspects, the one or more capabilities may include (but may not be limited to) a supported guard band size between the uplink subband and the downlink subband, a threshold size of the uplink subband supported by the UE 115, a threshold size of the downlink subband supported by the UE 115, or any combination thereof.

In some implementations, the uplink subband may correspond to a respective virtual uplink BWP and the downlink subband may correspond to a respective virtual downlink BWP, and the UE 115 may receive the second information indicative of the SBFD configuration by receiving an indication of a resource allocation of a scheduled physical channel for SBFD communications via a bitmap, where a resource block group size of the resource allocation is based on a size of the uplink subband, a size of the downlink subband, or both.

In some implementations, the uplink subband may correspond to a respective virtual uplink BWP and the downlink subband may correspond to a respective virtual downlink BWP, and receiving the second information indicative of the SBFD configuration includes receiving an indication of a resource allocation of a scheduled physical channel at the uplink subband, the downlink subband or both. In such implementations, the resource allocation of the scheduled physical channel may include a RIV that includes an indication of a starting resource block of the resource allocation that is with reference to a first resource block of the uplink subband or a first resource block of the downlink subband. In some other implementations, the UE 115, as part of the second information, may receive an indication of a physical channel resource allocation configured with frequency hopping within the downlink subband, the uplink subband, or both, and the physical channel resource allocation indicates a starting resource block of each hop of the frequency hopping relative to a first resource block of the uplink subband. In addition, a resource block offset may be based on a size of the uplink subband, the downlink subband, or both.

In some aspects, receiving the second information indicative of the SBFD configuration may include receiving respective uplink and downlink BWP configurations for the uplink subband, the downlink subband, or both, where the SBFD configuration is indicated jointly in each uplink and downlink BWP configuration, or separately for each uplink and downlink BWP configuration. In some examples, the SBFD configuration includes frequency location information for the uplink subband, the downlink subband, or both, one or more RIVs, subcarrier spacing information, time domain information, semi-persistent scheduling information, one or more uplink channel configurations, one or more downlink channel configurations, one or more uplink reference signal configurations, one or more downlink reference signal configurations or any combination thereof.

In some implementations, the SBFD configuration may be configured in accordance with a common resource block grid of a cell (e.g., a network carrier and an associated network carrier bandwidth, a carrier of the UE and the channel bandwidth of the UE, or both) configured for SBFD communications.

In some implementations, the UE 115 may be operating in a connected state (e.g., an RRC connected state), and the UE 115 may receive an SBFD configuration that includes a time pattern or an indication of resources for SBFD communications. In some examples, the time pattern or indication of resources may be for each of the one or more BWP pairs. In some examples, the time pattern or indication of the resources may be received via a cell common configuration of a broadcast message such as a SIB. In some other examples, the UE 115 may receive broadcast signaling that indicates that the uplink subband, the downlink subband, or both, are configured relative to an initial BWP, and are configured based at least in part on a serving cell bandwidth, or both.

At 1115, the UE 115 may communicate one or more messages via the one or more BWP pairs in accordance with the SBFD configuration. In some examples, the SBFD configuration may include a RIV that indicates a resource allocation associated with the uplink subband, the downlink subband or both, and the RIV may also include an indication of a starting resource block of the resource allocation (e.g., indicated relative to a first physical resource block of a carrier bandwidth, or relative to a first physical resource block of an active BWP of the one or more BWP pairs of the channel bandwidth of the UE 115) and a quantity of resource blocks included in the resource allocation.

In some aspects, the UE 115 may communicate the one or more messages via frequency resources of the uplink subband, the downlink subband, or both, based on one or more physical resource blocks that at least partially overlap with the respective uplink BWP, the respective downlink BWP, or both, of the SBFD configuration. In some other examples, the UE 115 may drop one or more physical resource blocks of the respective uplink BWP, the respective downlink BWP, or both, based on a subcarrier spacing of the respective uplink BWP, the respective downlink BWP, or both, being greater than a corresponding subcarrier spacing of the uplink subband, the downlink subband, or both.

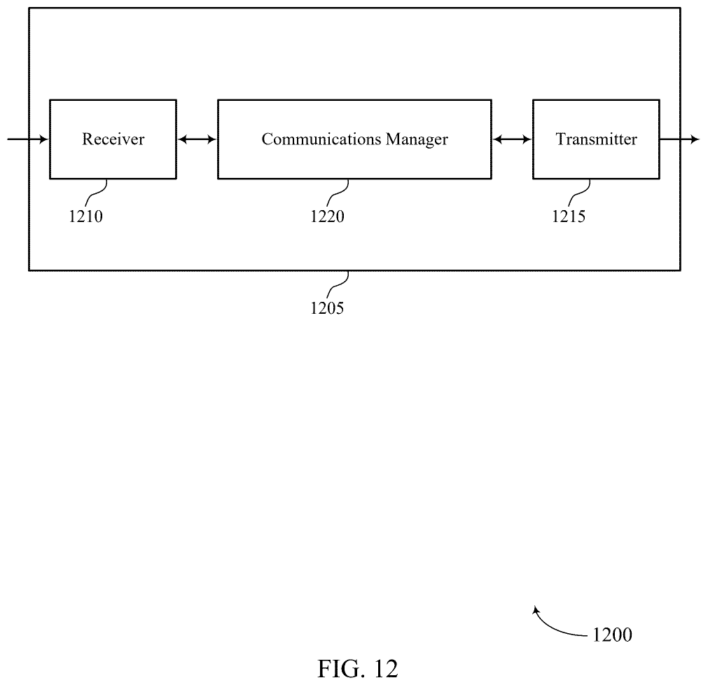

FIG. 12 shows a block diagram 1200 of a device 1205 that supports subband configuration techniques for SBFD in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to subband configuration techniques for SBFD). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to subband configuration techniques for SBFD). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of subband configuration techniques for SBFD as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving first information indicative of one or more BWP pairs configured for the UE, each BWP pair of the one or more BWP pairs including a respective uplink BWP and a respective downlink BWP that at least partially occupy a channel bandwidth of the UE. The communications manager 1220 is capable of, configured to, or operable to support a means for receiving second information indicative of a SBFD configuration for each of the one or more BWP pairs, where the SBFD configuration indicates an uplink subband, a downlink subband or both, that corresponds to each of the one or more BWP pairs. The communications manager 1220 is capable of, configured to, or operable to support a means for communicating one or more messages via the one or more BWP pairs in accordance with the SBFD configuration.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced ambiguity for resource allocation for SBFD communications, and more efficient utilization of uplink and downlink communication resources based on per-BWP configuration of SBFD communications.

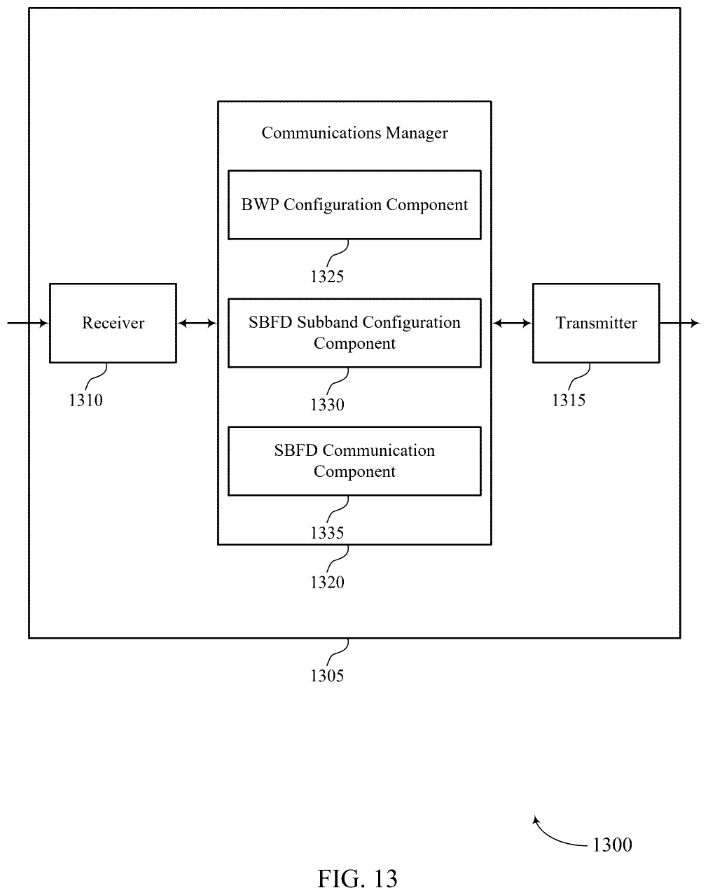

FIG. 13 shows a block diagram 1300 of a device 1305 that supports subband configuration techniques for SBFD in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to subband configuration techniques for SBFD). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to subband configuration techniques for SBFD). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of subband configuration techniques for SBFD as described herein. For example, the communications manager 1320 may include a BWP configuration component 1325, an SBFD subband configuration component 1330, an SBFD communication component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The BWP configuration component 1325 is capable of, configured to, or operable to support a means for receiving first information indicative of one or more BWP pairs configured for the UE, each BWP pair of the one or more BWP pairs including a respective uplink BWP and a respective downlink BWP that at least partially occupy a channel bandwidth of the UE. The SBFD subband configuration component 1330 is capable of, configured to, or operable to support a means for receiving second information indicative of a SBFD configuration for each of the one or more BWP pairs, where the SBFD configuration indicates an uplink subband, a downlink subband or both, that corresponds to each of the one or more BWP pairs. The SBFD communication component 1335 is capable of, configured to, or operable to support a means for communicating one or more messages via the one or more BWP pairs in accordance with the SBFD configuration.

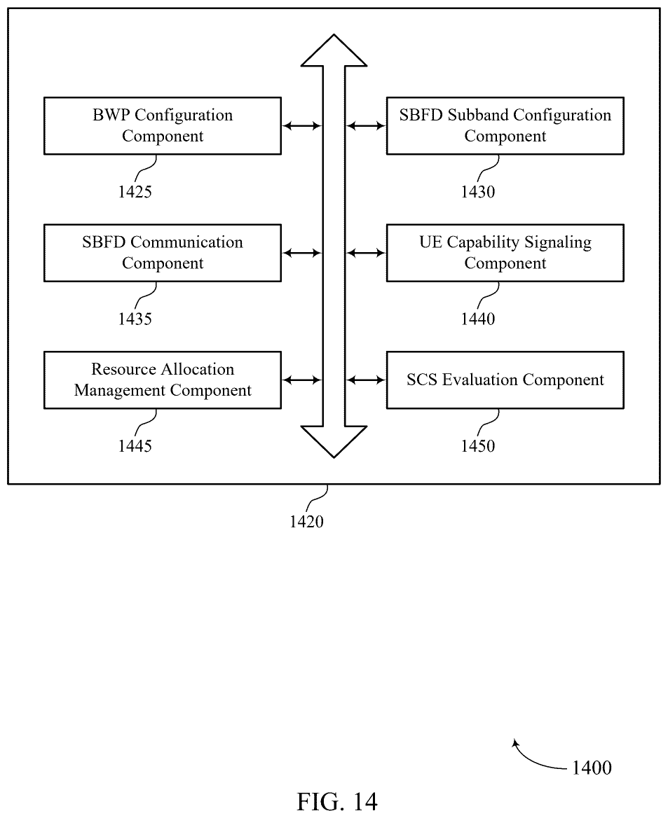

FIG. 14 shows a block diagram 1400 of a communications manager 1420 that supports subband configuration techniques for SBFD in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of subband configuration techniques for SBFD as described herein. For example, the communications manager 1420 may include a BWP configuration component 1425, an SBFD subband configuration component 1430, an SBFD communication component 1435, a UE capability signaling component 1440, a resource allocation management component 1445, an SCS evaluation component 1450, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The BWP configuration component 1425 is capable of, configured to, or operable to support a means for receiving first information indicative of one or more BWP pairs configured for the UE, each BWP pair of the one or more BWP pairs including a respective uplink BWP and a respective downlink BWP that at least partially occupy a channel bandwidth of the UE. The SBFD subband configuration component 1430 is capable of, configured to, or operable to support a means for receiving second information indicative of a SBFD configuration for each of the one or more BWP pairs, where the SBFD configuration indicates an uplink subband, a downlink subband or both, that corresponds to each of the one or more BWP pairs. The SBFD communication component 1435 is capable of, configured to, or operable to support a means for communicating one or more messages via the one or more BWP pairs in accordance with the SBFD configuration.

In some examples, to support receiving the second information, the UE capability signaling component 1440 is capable of, configured to, or operable to support a means for transmitting an indication of one or more capabilities of the UE. In some examples, to support receiving the second information, the SBFD subband configuration component 1430 is capable of, configured to, or operable to support a means for receiving, responsive to the indication, the second information indicative of the SBFD configuration, where the SBFD configuration is based on the one or more capabilities of the UE.

In some examples, the SBFD configuration includes a resource indication value that indicates a resource allocation associated with the uplink subband, the downlink subband or both. In some examples, the resource indication value includes an indication of a starting resource block of the resource allocation and a quantity of resource blocks included in the resource allocation. In some examples, the starting resource block is indicated relative to a first physical resource block of a carrier bandwidth.

In some examples, the starting resource block is indicated relative to a first physical resource block of an active BWP of the one or more BWP pairs of the channel bandwidth of the UE. In some examples, the uplink subband, the downlink subband, or both, are configured in an active BWP pair of the one or more BWP pairs.

In some examples, the SBFD configuration is based on one or more capabilities of the UE, the one or more capabilities including a supported guard band size between the uplink subband and the downlink subband, a threshold size of the uplink subband, a threshold size of the downlink subband, or any combination thereof.

In some examples, to support receiving the second information indicative of the SBFD configuration, the resource allocation management component 1445 is capable of, configured to, or operable to support a means for receiving an indication of a resource allocation of a scheduled physical channel for SBFD communications via a bitmap, where a resource block group size of the resource allocation is based on a size of the uplink subband, a size of the downlink subband, or both.

In some examples, to support receiving the second information indicative of the SBFD configuration, the resource allocation management component 1445 is capable of, configured to, or operable to support a means for receiving an indication of a resource allocation of a scheduled physical channel at the uplink subband, the downlink subband or both, where the resource allocation of the scheduled physical channel includes a resource indication value that includes an indication of a starting resource block of the resource allocation that is with reference to a first resource block of the uplink subband or a first resource block of the downlink subband.

In some examples, to support receiving the second information indicative of the SBFD configuration, the resource allocation management component 1445 is capable of, configured to, or operable to support a means for receiving an indication of a physical channel resource allocation configured with frequency hopping within the downlink subband, the uplink subband, or both, where the physical channel resource allocation indicates a starting resource block of each hop of the frequency hopping relative to a first resource block of the uplink subband, and where a resource block offset is based on a size of the uplink subband, the downlink subband, or both.

In some examples, to support receiving the second information indicative of the SBFD configuration, the SBFD subband configuration component 1430 is capable of, configured to, or operable to support a means for receiving the second information indicative of the SBFD configuration in respective uplink and downlink BWP configurations for the uplink subband, the downlink subband, or both, where the SBFD configuration is indicated jointly in each uplink and downlink BWP configuration, or separately for each uplink and downlink BWP configuration.

In some examples, the SBFD configuration includes frequency location information for the uplink subband, the downlink subband, or both, one or more resource indication values, subcarrier spacing information, time domain information, semi-persistent scheduling information, one or more uplink channel configurations, one or more downlink channel configurations, one or more uplink reference signal configurations, one or more downlink reference signal configurations or any combination thereof.

In some examples, the SBFD configuration including the uplink subband, the downlink subband or both, is configured in accordance with a common resource block grid of a cell configured for SBFD communications. In some examples, the cell includes a network carrier and an associated network carrier bandwidth, a carrier of the UE and the channel bandwidth of the UE, or both.

In some examples, to support communicating the one or more messages, the SBFD communication component 1435 is capable of, configured to, or operable to support a means for communicating the one or more messages via frequency resources of the uplink subband, the downlink subband, or both, based on one or more physical resource blocks that at least partially overlap with the respective uplink BWP, the respective downlink BWP, or both, of the SBFD configuration.

In some examples, the SCS evaluation component 1450 is capable of, configured to, or operable to support a means for dropping one or more physical resource blocks of the respective uplink BWP, the respective downlink BWP, or both, based on a subcarrier spacing of the respective uplink BWP, the respective downlink BWP, or both, being greater than a corresponding subcarrier spacing of the uplink subband, the downlink subband, or both.

In some examples, to support receiving the second information indicative of the SBFD configuration, the SBFD subband configuration component 1430 is capable of, configured to, or operable to support a means for receiving, while the UE is in a connected state, the second information indicative of the SBFD configuration via a serving cell configuration message, where the SBFD configuration includes a time pattern or an indication of resources for SBFD communications.

In some examples, to support receiving the second information indicative of the SBFD configuration, the SBFD subband configuration component 1430 is capable of, configured to, or operable to support a means for receiving, while the UE is in a connected state, the second information indicative of the SBFD configuration for each of the one or more BWP pairs, where the SBFD configuration includes a time pattern or an indication of resources for SBFD communications.

In some examples, to support receiving the second information indicative of the SBFD configuration, the SBFD subband configuration component 1430 is capable of, configured to, or operable to support a means for receiving, while the UE is in a connected state, an idle state, or an inactive state, the second information indicative of the SBFD configuration via a cell common configuration of a broadcast message, where the SBFD configuration includes a time pattern or an indication of resources for SBFD communications. In some examples, receiving the SBFD configuration includes a SBFD pattern periodicity that is based on a time division duplexing (TDD) downlink and uplink periodicity.

In some examples, the UE is operating in an inactive state or an idle state and, to support receiving the second information indicative of the SBFD configuration, the SBFD subband configuration component 1430 is capable of, configured to, or operable to support a means for receiving the second information indicative of the SBFD configuration via one or more broadcast system information messages, where the uplink subband, the downlink subband, or both, are configured relative to an initial BWP, are configured based on a serving cell bandwidth, or both.

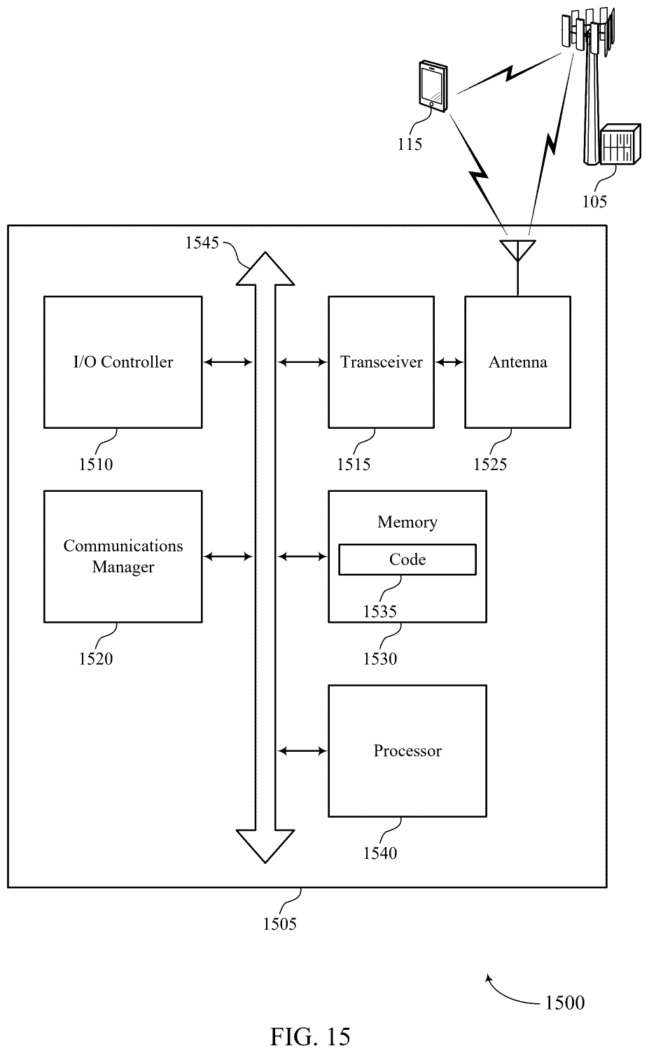

FIG. 15 shows a diagram of a system 1500 including a device 1505 that supports subband configuration techniques for SBFD in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting subband configuration techniques for SBFD). For example, the device 1505 or a component of the device 1505 may include at least one processor 1540 and at least one memory 1530 coupled with or to the at least one processor 1540, the at least one processor 1540 and the at least one memory 1530 configured to perform various functions described herein. In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for receiving first information indicative of one or more BWP pairs configured for the UE, each BWP pair of the one or more BWP pairs including a respective uplink BWP and a respective downlink BWP that at least partially occupy a channel bandwidth of the UE. The communications manager 1520 is capable of, configured to, or operable to support a means for receiving second information indicative of a SBFD configuration for each of the one or more BWP pairs, where the SBFD configuration indicates an uplink subband, a downlink subband or both, that corresponds to each of the one or more BWP pairs. The communications manager 1520 is capable of, configured to, or operable to support a means for communicating one or more messages via the one or more BWP pairs in accordance with the SBFD configuration.

By including or configuring the communications manager 1520 in accordance with examples as described herein, the device 1505 may support techniques for improved communication reliability, reduced latency due to enhanced SBFD communications techniques and resource allocation, more efficient utilization of uplink and downlink communication resources in SBFD, improved coordination between devices, reduced ambiguity of resource allocation for SBFD uplink and downlink subbands, among other advantages.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of subband configuration techniques for SBFD as described herein, or the at least one processor 1540 and the at least one memory 1530 may be otherwise configured to, individually or collectively, perform or support such operations.

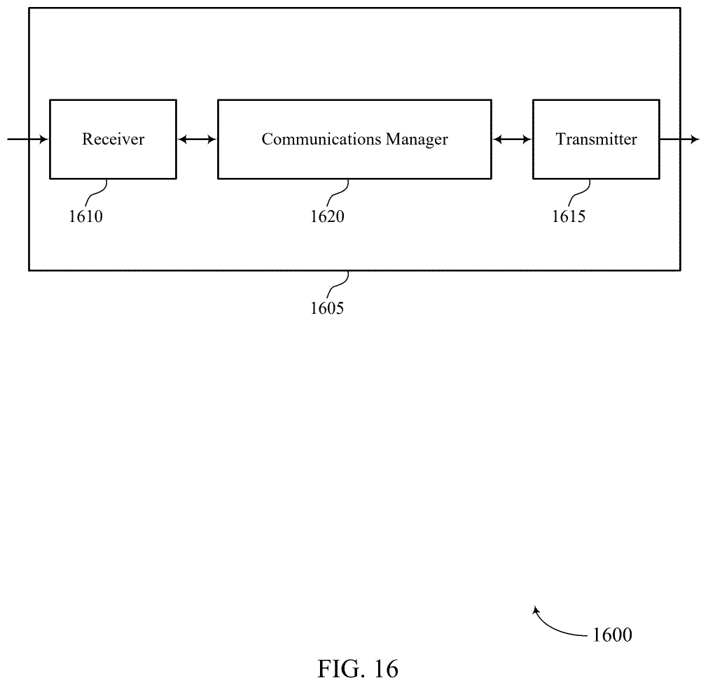

FIG. 16 shows a block diagram 1600 of a device 1605 that supports subband configuration techniques for SBFD in accordance with one or more aspects of the present disclosure. The device 1605 may be an example of aspects of a network entity 105 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to, individually or collectively, support or enable the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations or components thereof may be examples of means for performing various aspects of subband configuration techniques for SBFD as described herein. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1620, the receiver 1610, the transmitter 1615, or various combinations or components thereof may be implemented in code (e.g., as communications management software or firmware) executed by at least one processor (e.g., referred to as a processor-executable code). If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. For example, the communications manager 1620 is capable of, configured to, or operable to support a means for outputting first information indicative of one or more BWP pairs configured for a UE, each BWP pair of the one or more BWP pairs including a respective uplink BWP and a respective downlink BWP that at least partially occupy a channel bandwidth of the UE. The communications manager 1620 is capable of, configured to, or operable to support a means for outputting second information indicative of a SBFD configuration for each of the one or more BWP pairs, where the SBFD configuration indicates an uplink subband, a downlink subband or both, that corresponds to each of the one or more BWP pairs. The communications manager 1620 is capable of, configured to, or operable to support a means for communicating one or more messages via the one or more BWP pairs in accordance with the SBFD configuration.

By including or configuring the communications manager 1620 in accordance with examples as described herein, the device 1605 (e.g., at least one processor controlling or otherwise coupled with the receiver 1610, the transmitter 1615, the communications manager 1620, or a combination thereof) may support techniques for reduced processing, reduced ambiguity for resource allocation for SBFD communications, and more efficient utilization of uplink and downlink communication resources based on per-BWP configuration of SBFD communications.

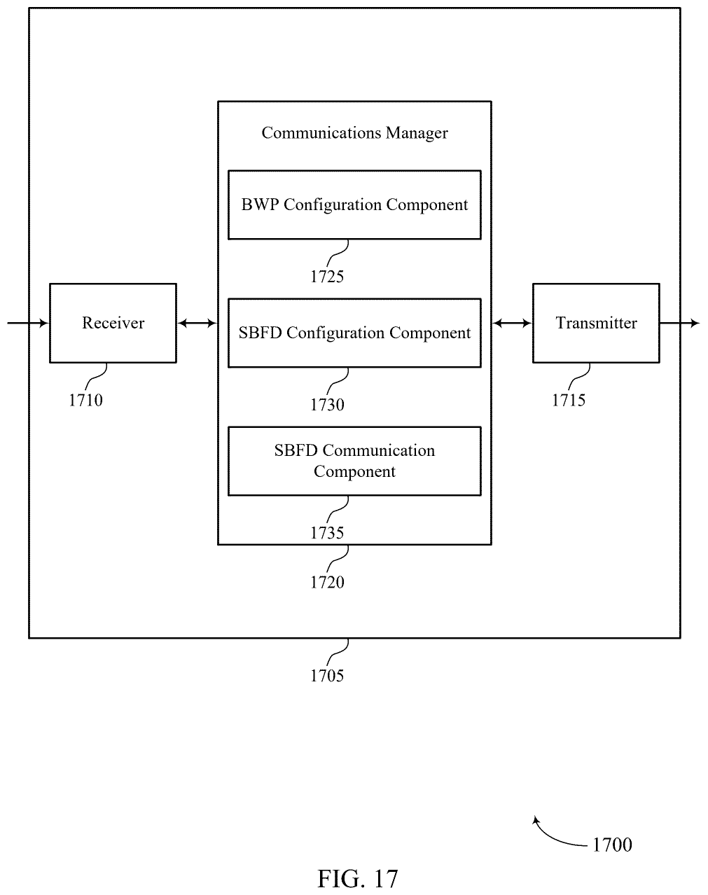

FIG. 17 shows a block diagram 1700 of a device 1705 that supports subband configuration techniques for SBFD in accordance with one or more aspects of the present disclosure. The device 1705 may be an example of aspects of a device 1605 or a network entity 105 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to support the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of subband configuration techniques for SBFD as described herein. For example, the communications manager 1720 may include a BWP configuration component 1725, an SBFD configuration component 1730, an SBFD communication component 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications in accordance with examples as disclosed herein. The BWP configuration component 1725 is capable of, configured to, or operable to support a means for outputting first information indicative of one or more BWP pairs configured for a UE, each BWP pair of the one or more BWP pairs including a respective uplink BWP and a respective downlink BWP that at least partially occupy a channel bandwidth of the UE. The SBFD configuration component 1730 is capable of, configured to, or operable to support a means for outputting second information indicative of a SBFD configuration for each of the one or more BWP pairs, where the SBFD configuration indicates an uplink subband, a downlink subband or both, that corresponds to each of the one or more BWP pairs. The SBFD communication component 1735 is capable of, configured to, or operable to support a means for communicating one or more messages via the one or more BWP pairs in accordance with the SBFD configuration.

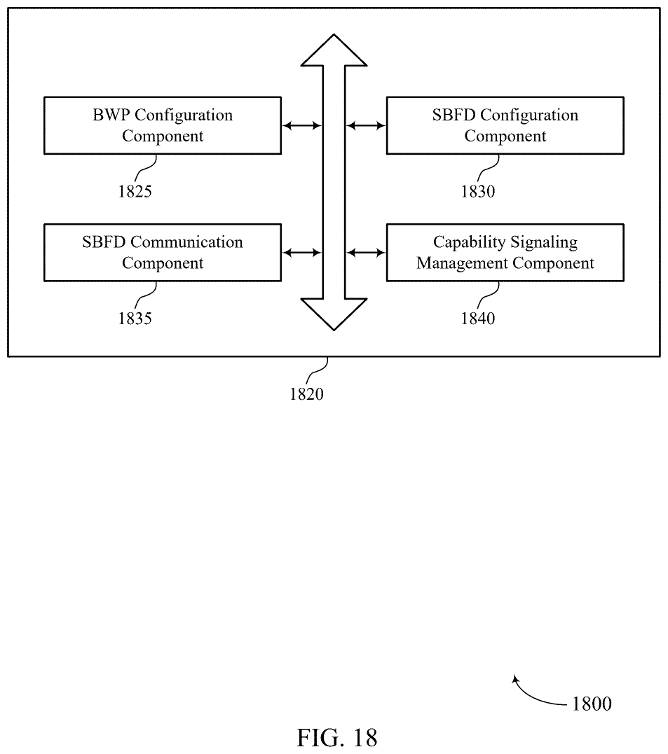

FIG. 18 shows a block diagram 1800 of a communications manager 1820 that supports subband configuration techniques for SBFD in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of subband configuration techniques for SBFD as described herein. For example, the communications manager 1820 may include a BWP configuration component 1825, an SBFD configuration component 1830, an SBFD communication component 1835, a capability signaling management component 1840, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1820 may support wireless communications in accordance with examples as disclosed herein. The BWP configuration component 1825 is capable of, configured to, or operable to support a means for outputting first information indicative of one or more BWP pairs configured for a UE, each BWP pair of the one or more BWP pairs including a respective uplink BWP and a respective downlink BWP that at least partially occupy a channel bandwidth of the UE. The SBFD configuration component 1830 is capable of, configured to, or operable to support a means for outputting second information indicative of a SBFD configuration for each of the one or more BWP pairs, where the SBFD configuration indicates an uplink subband, a downlink subband or both, that corresponds to each of the one or more BWP pairs. The SBFD communication component 1835 is capable of, configured to, or operable to support a means for communicating one or more messages via the one or more BWP pairs in accordance with the SBFD configuration.

In some examples, to support outputting the second information, the capability signaling management component 1840 is capable of, configured to, or operable to support a means for obtaining an indication of one or more capabilities of the UE. In some examples, to support outputting the second information, the SBFD configuration component 1830 is capable of, configured to, or operable to support a means for outputting, responsive to the indication, the second information indicative of the SBFD configuration, where the SBFD configuration is based on the one or more capabilities of the UE.

In some examples, the SBFD configuration includes a resource indication value that indicates a resource allocation associated with the uplink subband, the downlink subband or both. In some examples, the resource indication value includes an indication of a starting resource block of the resource allocation and a quantity of resource blocks included in the resource allocation. In some examples, the starting resource block is indicated relative to a first physical resource block of a carrier bandwidth. In some examples, the starting resource block is indicated relative to a first physical resource block of an active BWP of the one or more BWP pairs of the channel bandwidth of the UE. In some examples, the uplink subband, the downlink subband, or both, are configured in an active BWP pair of the one or more BWP pairs. In some examples, the SBFD configuration is based on one or more capabilities of the UE, the one or more capabilities including a supported guard band size between the uplink subband and the downlink subband, a threshold size of the uplink subband, a threshold size of the downlink subband, or any combination thereof.

In some examples, to support outputting the second information indicative of the SBFD configuration, the SBFD configuration component 1830 is capable of, configured to, or operable to support a means for outputting an indication of a resource allocation of a scheduled physical channel for SBFD communications via a bitmap, where a resource block group size of the resource allocation is based on a size of the uplink subband, a size of the downlink subband, or both.

In some examples, to support outputting the second information indicative of the SBFD configuration, the SBFD configuration component 1830 is capable of, configured to, or operable to support a means for receiving an indication of a resource allocation of a scheduled physical channel at the uplink subband, the downlink subband or both, where the resource allocation of the scheduled physical channel includes a resource indication value that includes an indication of a starting resource block of the resource allocation that is with reference to a first resource block of the uplink subband or a first resource block of the downlink subband.

In some examples, to support outputting the second information indicative of the SBFD configuration, the SBFD configuration component 1830 is capable of, configured to, or operable to support a means for outputting an indication of a physical channel resource allocation configured with frequency hopping within the downlink subband, the uplink subband, or both, where the physical channel resource allocation indicates a starting resource block of each hop of the frequency hopping relative to a first resource block of the uplink subband, and where a resource block offset is based on a size of the uplink subband, the downlink subband, or both.

In some examples, to support outputting the second information indicative of the SBFD configuration, the SBFD configuration component 1830 is capable of, configured to, or operable to support a means for outputting the second information indicative of the SBFD configuration in respective uplink and downlink BWP configurations for the uplink subband, the downlink subband, or both, where the SBFD configuration is indicated jointly in each uplink and downlink BWP configuration, or separately for each uplink and downlink BWP configuration.

In some examples, the SBFD configuration includes frequency location information for the uplink subband, the downlink subband, or both, one or more resource indication values, subcarrier spacing information, time domain information, semi-persistent scheduling information, one or more uplink channel configurations, one or more downlink channel configurations, one or more uplink reference signal configurations, one or more downlink reference signal configurations or any combination thereof. In some examples, the SBFD configuration including the uplink subband, the downlink subband or both, is configured in accordance with a common resource block grid of a cell configured for SBFD communications. In some examples, the cell includes a network carrier and an associated network carrier bandwidth, a carrier of the UE and the channel bandwidth of the UE, or both.

In some examples, to support communicating the one or more messages, the SBFD communication component 1835 is capable of, configured to, or operable to support a means for communicating the one or more messages via frequency resources of the uplink subband, the downlink subband, or both, based on one or more physical resource blocks that at least partially overlap with the respective uplink BWP, the respective downlink BWP, or both, of the SBFD configuration.

In some examples, to support outputting the second information indicative of the SBFD configuration, the SBFD configuration component 1830 is capable of, configured to, or operable to support a means for outputting, while the UE is in a connected state, the second information indicative of the SBFD configuration via a serving cell configuration message, where the SBFD configuration includes a time pattern or an indication of resources for SBFD communications.

In some examples, to support outputting the second information indicative of the SBFD configuration, the SBFD configuration component 1830 is capable of, configured to, or operable to support a means for outputting, while the UE is in a connected state, the second information indicative of the SBFD configuration for each of the one or more BWP pairs, where the SBFD configuration includes a time pattern or an indication of resources for SBFD communications.

In some examples, to support receiving the second information indicative of the SBFD configuration, the SBFD configuration component 1830 is capable of, configured to, or operable to support a means for outputting, while the UE is in a connected state, an idle state, or an inactive state, the second information indicative of the SBFD configuration via a cell common configuration of a broadcast message, where the SBFD configuration includes a time pattern or an indication of resources for SBFD communications. In some examples, outputting the SBFD configuration includes a SBFD pattern periodicity that is based on a TDD downlink and uplink periodicity.

In some examples, to support outputting the second information indicative of the SBFD configuration, the SBFD configuration component 1830 is capable of, configured to, or operable to support a means for outputting the second information indicative of the SBFD configuration via one or more broadcast system information messages, where the uplink subband, the downlink subband, or both, are configured relative to an initial BWP, are configured based on a serving cell bandwidth, or both.

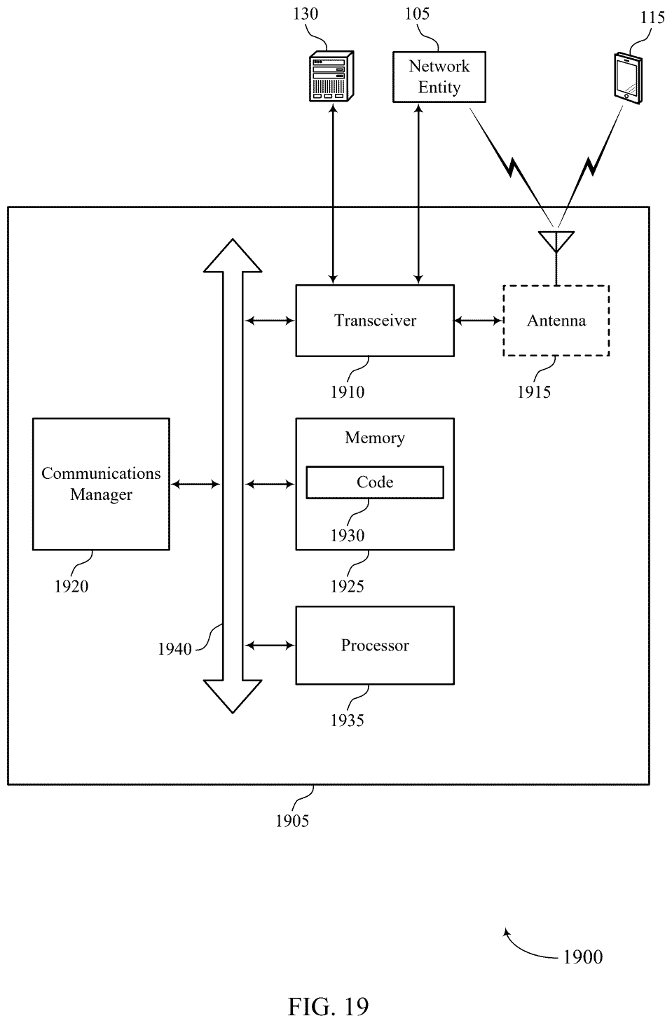

FIG. 19 shows a diagram of a system 1900 including a device 1905 that supports subband configuration techniques for SBFD in accordance with one or more aspects of the present disclosure. The device 1905 may be an example of or include components of a device 1605, a device 1705, or a network entity 105 as described herein. The device 1905 may communicate with other network devices or network equipment such as one or more of the network entities 105, UEs 115, or any combination thereof. The communications may include communications over one or more wired interfaces, over one or more wireless interfaces, or any combination thereof. The device 1905 may include components that support outputting and obtaining communications, such as a communications manager 1920, a transceiver 1910, one or more antennas 1915, at least one memory 1925, code 1930, and at least one processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or one or more memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or one or more memory components (e.g., the at least one processor 1935, the at least one memory 1925, or both), may be included in a chip or chip assembly that is installed in the device 1905. In some examples, the transceiver 1910 may be operable to support communications via one or more communications links (e.g., communication link(s) 125, backhaul communication link(s) 120, a midhaul communication link 162, a fronthaul communication link 168).

The at least one memory 1925 may include RAM, ROM, or any combination thereof. The at least one memory 1925 may store computer-readable, computer-executable, or processor-executable code, such as the code 1930. The code 1930 may include instructions that, when executed by one or more of the at least one processor 1935, cause the device 1905 to perform various functions described herein. The code 1930 may be stored in a non-transitory computer-readable medium such as system memory or another type of memory. In some cases, the code 1930 may not be directly executable by a processor of the at least one processor 1935 but may cause a computer (e.g., when compiled and executed) to perform functions described herein. In some cases, the at least one memory 1925 may include, among other things, a BIOS which may control basic hardware or software operation such as the interaction with peripheral components or devices. In some examples, the at least one processor 1935 may include multiple processors and the at least one memory 1925 may include multiple memories. One or more of the multiple processors may be coupled with one or more of the multiple memories which may, individually or collectively, be configured to perform various functions herein (for example, as part of a processing system).

The at least one processor 1935 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1935 may be configured to operate a memory array using a memory controller. In some other cases, a memory controller may be integrated into one or more of the at least one processor 1935. The at least one processor 1935 may be configured to execute computer-readable instructions stored in a memory (e.g., one or more of the at least one memory 1925) to cause the device 1905 to perform various functions (e.g., functions or tasks supporting subband configuration techniques for SBFD). For example, the device 1905 or a component of the device 1905 may include at least one processor 1935 and at least one memory 1925 coupled with one or more of the at least one processor 1935, the at least one processor 1935 and the at least one memory 1925 configured to perform various functions described herein. The at least one processor 1935 may be an example of a cloud-computing platform (e.g., one or more physical nodes and supporting software such as operating systems, virtual machines, or container instances) that may host the functions (e.g., by executing code 1930) to perform the functions of the device 1905. The at least one processor 1935 may be any one or more suitable processors capable of executing scripts or instructions of one or more software programs stored in the device 1905 (such as within one or more of the at least one memory 1925). In some examples, the at least one processor 1935 may include multiple processors and the at least one memory 1925 may include multiple memories. One or more of the multiple processors may be coupled with one or more of the multiple memories, which may, individually or collectively, be configured to perform various functions herein. In some examples, the at least one processor 1935 may be a component of a processing system, which may refer to a system (such as a series) of machines, circuitry (including, for example, one or both of processor circuitry (which may include the at least one processor 1935) and memory circuitry (which may include the at least one memory 1925)), or components, that receives or obtains inputs and processes the inputs to produce, generate, or obtain a set of outputs. The processing system may be configured to perform one or more of the functions described herein. For example, the at least one processor 1935 or a processing system including the at least one processor 1935 may be configured to, configurable to, or operable to cause the device 1905 to perform one or more of the functions described herein. Further, as described herein, being “configured to,” being “configurable to,” and being “operable to” may be used interchangeably and may be associated with a capability, when executing code stored in the at least one memory 1925 or otherwise, to perform one or more of the functions described herein.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the at least one memory 1925, the code 1930, and the at least one processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with one or more other network entities 105, and may include a controller or scheduler for controlling communications with UEs 115 (e.g., in cooperation with the one or more other network devices). In some examples, the communications manager 1920 may support an X2 interface within an LTE/LTE-A wireless communications network technology to provide communication between network entities 105.

The communications manager 1920 may support wireless communications in accordance with examples as disclosed herein. For example, the communications manager 1920 is capable of, configured to, or operable to support a means for outputting first information indicative of one or more BWP pairs configured for a UE, each BWP pair of the one or more BWP pairs including a respective uplink BWP and a respective downlink BWP that at least partially occupy a channel bandwidth of the UE. The communications manager 1920 is capable of, configured to, or operable to support a means for outputting second information indicative of a SBFD configuration for each of the one or more BWP pairs, where the SBFD configuration indicates an uplink subband, a downlink subband or both, that corresponds to each of the one or more BWP pairs. The communications manager 1920 is capable of, configured to, or operable to support a means for communicating one or more messages via the one or more BWP pairs in accordance with the SBFD configuration.

By including or configuring the communications manager 1920 in accordance with examples as described herein, the device 1905 may support techniques for improved communication reliability, reduced latency due to enhanced SBFD communications techniques and resource allocation, more efficient utilization of uplink and downlink communication resources in SBFD, improved coordination between devices, reduced ambiguity of resource allocation for SBFD uplink and downlink subbands, among other advantages.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. Although the communications manager 1920 is illustrated as a separate component, in some examples, one or more functions described with reference to the communications manager 1920 may be supported by or performed by the transceiver 1910, one or more of the at least one processor 1935, one or more of the at least one memory 1925, the code 1930, or any combination thereof (for example, by a processing system including at least a portion of the at least one processor 1935, the at least one memory 1925, the code 1930, or any combination thereof). For example, the code 1930 may include instructions executable by one or more of the at least one processor 1935 to cause the device 1905 to perform various aspects of subband configuration techniques for SBFD as described herein, or the at least one processor 1935 and the at least one memory 1925 may be otherwise configured to, individually or collectively, perform or support such operations.

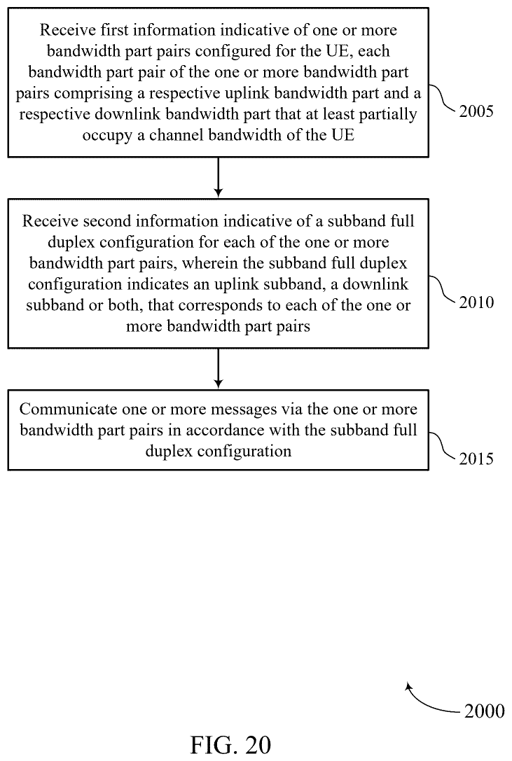

FIG. 20 shows a flowchart illustrating a method 2000 that supports subband configuration techniques for SBFD in accordance with one or more aspects of the present disclosure. The operations of the method 2000 may be implemented by a UE or its components as described herein. For example, the operations of the method 2000 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2005, the method may include receiving first information indicative of one or more BWP pairs configured for the UE, each BWP pair of the one or more BWP pairs comprising a respective uplink BWP and a respective downlink BWP that at least partially occupy a channel bandwidth of the UE. The operations of 2005 may be performed in accordance with examples as disclosed herein. In some examples, aspects of the operations of 2005 may be performed by a BWP configuration component 1425 as described with reference to FIG. 14.

At 2010, the method may include receiving second information indicative of a SBFD configuration for each of the one or more BWP pairs, wherein the SBFD configuration indicates an uplink subband, a downlink subband or both, that corresponds to each of the one or more BWP pairs. The operations of 2010 may be performed in accordance with examples as disclosed herein. In some examples, aspects of the operations of 2010 may be performed by an SBFD subband configuration component 1430 as described with reference to FIG. 14.

At 2015, the method may include communicating one or more messages via the one or more BWP pairs in accordance with the SBFD configuration. The operations of 2015 may be performed in accordance with examples as disclosed herein. In some examples, aspects of the operations of 2015 may be performed by an SBFD communication component 1435 as described with reference to FIG. 14.

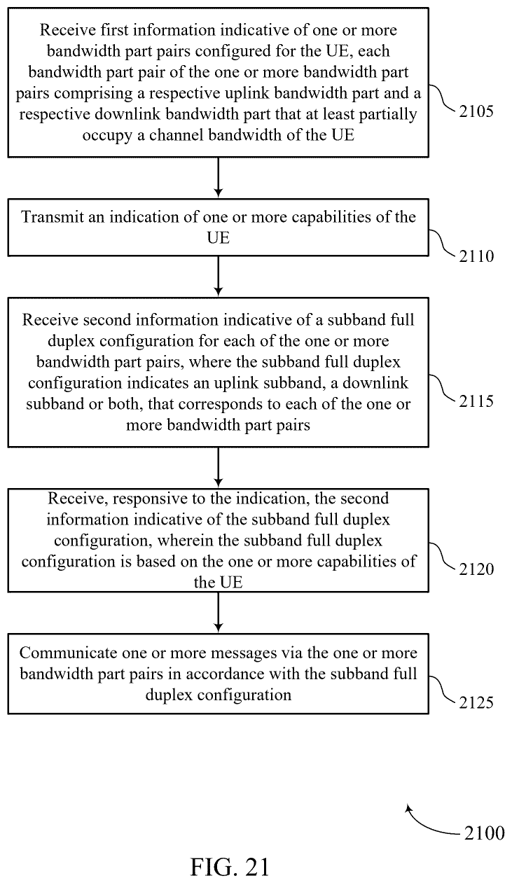

FIG. 21 shows a flowchart illustrating a method 2100 that supports subband configuration techniques for SBFD in accordance with one or more aspects of the present disclosure. The operations of the method 2100 may be implemented by a UE or its components as described herein. For example, the operations of the method 2100 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2105, the method may include receiving first information indicative of one or more BWP pairs configured for the UE, each BWP pair of the one or more BWP pairs comprising a respective uplink BWP and a respective downlink BWP that at least partially occupy a channel bandwidth of the UE. The operations of 2105 may be performed in accordance with examples as disclosed herein. In some examples, aspects of the operations of 2105 may be performed by a BWP configuration component 1425 as described with reference to FIG. 14.

At 2110, the method may include transmitting an indication of one or more capabilities of the UE. The operations of 2110 may be performed in accordance with examples as disclosed herein. In some examples, aspects of the operations of 2110 may be performed by a UE capability signaling component 1440 as described with reference to FIG. 14.

At 2115, the method may include receiving second information indicative of a SBFD configuration for each of the one or more BWP pairs, wherein the SBFD configuration indicates an uplink subband, a downlink subband or both, that corresponds to each of the one or more BWP pairs. The operations of 2115 may be performed in accordance with examples as disclosed herein. In some examples, aspects of the operations of 2115 may be performed by an SBFD subband configuration component 1430 as described with reference to FIG. 14.

At 2120, the method may include receiving, responsive to the indication, the second information indicative of the SBFD configuration, where the SBFD configuration is based on the one or more capabilities of the UE. The operations of 2120 may be performed in accordance with examples as disclosed herein. In some examples, aspects of the operations of 2120 may be performed by an SBFD subband configuration component 1430 as described with reference to FIG. 14.

At 2125, the method may include communicating one or more messages via the one or more BWP pairs in accordance with the SBFD configuration. The operations of 2125 may be performed in accordance with examples as disclosed herein. In some examples, aspects of the operations of 2125 may be performed by an SBFD communication component 1435 as described with reference to FIG. 14.

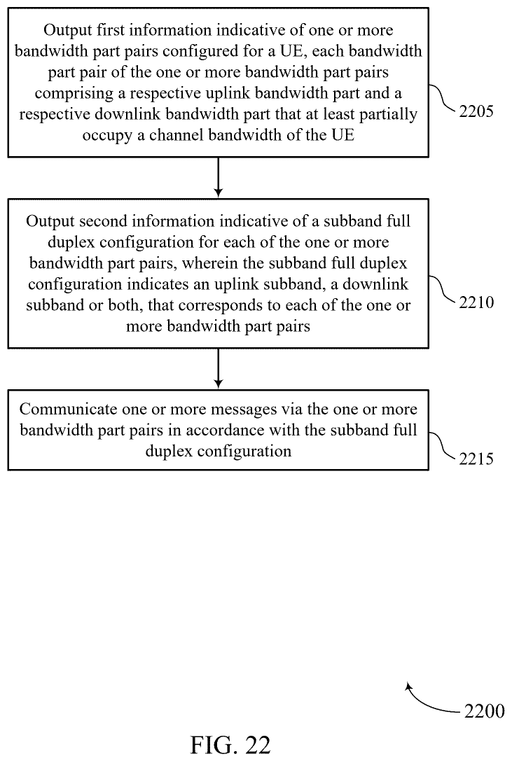

FIG. 22 shows a flowchart illustrating a method 2200 that supports subband configuration techniques for SBFD in accordance with one or more aspects of the present disclosure. The operations of the method 2200 may be implemented by a network entity or its components as described herein. For example, the operations of the method 2200 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2205, the method may include outputting first information indicative of one or more BWP pairs configured for a UE, each BWP pair of the one or more BWP pairs comprising a respective uplink BWP and a respective downlink BWP that at least partially occupy a channel bandwidth of the UE. The operations of 2205 may be performed in accordance with examples as disclosed herein. In some examples, aspects of the operations of 2205 may be performed by a BWP configuration component 1825 as described with reference to FIG. 18.

At 2210, the method may include outputting second information indicative of a SBFD configuration for each of the one or more BWP pairs, wherein the SBFD configuration indicates an uplink subband, a downlink subband or both, that corresponds to each of the one or more BWP pairs. The operations of 2210 may be performed in accordance with examples as disclosed herein. In some examples, aspects of the operations of 2210 may be performed by an SBFD configuration component 1830 as described with reference to FIG. 18.

At 2215, the method may include communicating one or more messages via the one or more BWP pairs in accordance with the SBFD configuration. The operations of 2215 may be performed in accordance with examples as disclosed herein. In some examples, aspects of the operations of 2215 may be performed by an SBFD communication component 1835 as described with reference to FIG. 18.

The following provides an overview of aspects of the present disclosure:

Aspect 1: A method for wireless communications at a UE, comprising: receiving first information indicative of one or more BWP pairs configured for the UE, each BWP pair of the one or more BWP pairs comprising a respective uplink BWP and a respective downlink BWP that at least partially occupy a channel bandwidth of the UE; receiving second information indicative of a SBFD configuration for each of the one or more BWP pairs, wherein the SBFD configuration indicates an uplink subband, a downlink subband or both, that corresponds to each of the one or more BWP pairs; and communicating one or more messages via the one or more BWP pairs in accordance with the SBFD configuration.

Aspect 2: The method of aspect 1, wherein receiving the second information comprises: transmitting an indication of one or more capabilities of the UE; and receiving, responsive to the indication, the second information indicative of the SBFD configuration, wherein the SBFD configuration is based at least in part on the one or more capabilities of the UE.

Aspect 3: The method of any of aspects 1 through 2, wherein the SBFD configuration includes a RIV that indicates a resource allocation associated with the uplink subband, the downlink subband or both, the RIV includes an indication of a starting resource block of the resource allocation and a quantity of resource blocks included in the resource allocation.

Aspect 4: The method of aspect 3, wherein the starting resource block is indicated relative to a first PRB of a carrier bandwidth.

Aspect 5: The method of any of aspects 3 through 4, wherein the starting resource block is indicated relative to a first PRB of an active BWP of the one or more BWP pairs of the channel bandwidth of the UE.

Aspect 6: The method of any of aspects 1 through 5, wherein the uplink subband, the downlink subband, or both, are configured in an active BWP pair of the one or more BWP pairs.

Aspect 7: The method of any of aspects 1 through 6, wherein the SBFD configuration is based at least in part on one or more capabilities of the UE, the one or more capabilities comprising a supported guard band size between the uplink subband and the downlink subband, a threshold size of the uplink subband, a threshold size of the downlink subband, or any combination thereof.

Aspect 8: The method of any of aspects 1 through 7, wherein the uplink subband corresponds to a respective virtual uplink BWP and the downlink subband corresponds to a respective virtual downlink BWP, and wherein receiving the second information indicative of the SBFD configuration comprises: receiving an indication of a resource allocation of a scheduled physical channel for SBFD communications via a bitmap, wherein a resource block group size of the resource allocation is based at least in part on a size of the uplink subband, a size of the downlink subband, or both.

Aspect 9: The method of any of aspects 1 through 8, wherein the uplink subband corresponds to a respective virtual uplink BWP and the downlink subband corresponds to a respective virtual downlink BWP, and wherein receiving the second information indicative of the SBFD configuration comprises: receiving an indication of a resource allocation of a scheduled physical channel at the uplink subband, the downlink subband or both, wherein the resource allocation of the scheduled physical channel comprises a RIV that includes an indication of a starting resource block of the resource allocation that is with reference to a first resource block of the uplink subband or a first resource block of the downlink subband.

Aspect 10: The method of any of aspects 1 through 9, wherein the uplink subband corresponds to a respective virtual uplink BWP and the downlink subband corresponds to a respective virtual downlink BWP, and wherein receiving the second information indicative of the SBFD configuration comprises: receiving an indication of a physical channel resource allocation configured with frequency hopping within the downlink subband, the uplink subband, or both, wherein the physical channel resource allocation indicates a starting resource block of each hop of the frequency hopping relative to a first resource block of the uplink subband, and wherein a resource block offset is based at least in part on a size of the uplink subband, the downlink subband, or both.

Aspect 11: The method of any of aspects 1 through 10, wherein receiving the second information indicative of the SBFD configuration comprises: receiving the second information indicative of the SBFD configuration in respective uplink and downlink BWP configurations for the uplink subband, the downlink subband, or both, wherein the SBFD configuration is indicated jointly in each uplink and downlink BWP configuration, or separately for each uplink and downlink BWP configuration.

Aspect 12: The method of aspect 11, wherein the SBFD configuration includes frequency location information for the uplink subband, the downlink subband, or both, one or more RIVs, subcarrier spacing information, time domain information, semi-persistent scheduling information, one or more uplink channel configurations, one or more downlink channel configurations, one or more uplink reference signal configurations, one or more downlink reference signal configurations or any combination thereof.

Aspect 13: The method of any of aspects 1 through 12, wherein the SBFD configuration including the uplink subband, the downlink subband or both, is configured in accordance with a common resource block grid of a cell configured for SBFD communications.

Aspect 14: The method of aspect 13, wherein the cell comprises a network carrier and an associated network carrier bandwidth, a carrier of the UE and the channel bandwidth of the UE, or both.

Aspect 15: The method of any of aspects 1 through 14, wherein communicating the one or more messages further comprises: communicating the one or more messages via frequency resources of the uplink subband, the downlink subband, or both, based at least in part on one or more PRBs that at least partially overlap with the respective uplink BWP, the respective downlink BWP, or both, of the SBFD configuration.

Aspect 16: The method of any of aspects 1 through 15, further comprising: dropping one or more PRBs of the respective uplink BWP, the respective downlink BWP, or both, based at least in part on a subcarrier spacing of the respective uplink BWP, the respective downlink BWP, or both, being greater than a corresponding subcarrier spacing of the uplink subband, the downlink subband, or both.

Aspect 17: The method of any of aspects 1 through 16, wherein receiving the second information indicative of the SBFD configuration comprises: receiving, while the UE is in a connected state, the second information indicative of the SBFD configuration via a serving cell configuration message, wherein the SBFD configuration comprises a time pattern or an indication of resources for SBFD communications.

Aspect 18: The method of any of aspects 1 through 17, wherein receiving the second information indicative of the SBFD configuration comprises: receiving, while the UE is in a connected state, the second information indicative of the SBFD configuration for each of the one or more BWP pairs, wherein the SBFD configuration comprises a time pattern or an indication of resources for SBFD communications.

Aspect 19: The method of any of aspects 1 through 18, wherein receiving the second information indicative of the SBFD configuration comprises: receiving, while the UE is in a connected state, an idle state, or an inactive state, the second information indicative of the SBFD configuration via a cell common configuration of a broadcast message, wherein the SBFD configuration comprises a time pattern or an indication of resources for SBFD communications.

Aspect 20: The method of any of aspects 1 through 19, wherein receiving the SBFD configuration comprises a SBFD pattern periodicity that is based at least in part on a TDD downlink and uplink periodicity.

Aspect 21: The method of any of aspects 1 through 20, wherein the UE is operating in an inactive state or an idle state, and receiving the second information indicative of the SBFD configuration comprises: receiving the second information indicative of the SBFD configuration via one or more broadcast system information messages, wherein the uplink subband, the downlink subband, or both, are configured relative to an initial BWP, are configured based at least in part on a serving cell bandwidth, or both.

Aspect 22: A method for wireless communications at a network entity, comprising: outputting first information indicative of one or more BWP pairs configured for a UE, each BWP pair of the one or more BWP pairs comprising a respective uplink BWP and a respective downlink BWP that at least partially occupy a channel bandwidth of the UE; outputting second information indicative of a SBFD configuration for each of the one or more BWP pairs, wherein the SBFD configuration indicates an uplink subband, a downlink subband or both, that corresponds to each of the one or more BWP pairs; and communicating one or more messages via the one or more BWP pairs in accordance with the SBFD configuration.

Aspect 23: The method of aspect 22, wherein outputting the second information comprises: obtaining an indication of one or more capabilities of the UE; and outputting, responsive to the indication, the second information indicative of the SBFD configuration, wherein the SBFD configuration is based at least in part on the one or more capabilities of the UE.

Aspect 24: The method of any of aspects 22 through 23, wherein the SBFD configuration includes a RIV that indicates a resource allocation associated with the uplink subband, the downlink subband or both, the RIV includes an indication of a starting resource block of the resource allocation and a quantity of resource blocks included in the resource allocation.

Aspect 25: The method of aspect 24, wherein the starting resource block is indicated relative to a first PRB of a carrier bandwidth.

Aspect 26: The method of any of aspects 24 through 25, wherein the starting resource block is indicated relative to a first PRB of an active BWP of the one or more BWP pairs of the channel bandwidth of the UE.

Aspect 27: The method of any of aspects 22 through 26, wherein the uplink subband, the downlink subband, or both, are configured in an active BWP pair of the one or more BWP pairs.

Aspect 28: The method of any of aspects 22 through 27, wherein the SBFD configuration is based at least in part on one or more capabilities of the UE, the one or more capabilities comprising a supported guard band size between the uplink subband and the downlink subband, a threshold size of the uplink subband, a threshold size of the downlink subband, or any combination thereof.

Aspect 29: The method of any of aspects 22 through 28, wherein the uplink subband corresponds to a respective virtual uplink BWP and the downlink subband corresponds to a respective virtual downlink BWP, and wherein outputting the second information indicative of the SBFD configuration comprises: outputting an indication of a resource allocation of a scheduled physical channel for SBFD communications via a bitmap, wherein a resource block group size of the resource allocation is based at least in part on a size of the uplink subband, a size of the downlink subband, or both.

Aspect 30: The method of any of aspects 22 through 29, wherein the uplink subband corresponds to a respective virtual uplink BWP and the downlink subband corresponds to a respective virtual downlink BWP, and wherein outputting the second information indicative of the SBFD configuration comprises: receiving an indication of a resource allocation of a scheduled physical channel at the uplink subband, the downlink subband or both, wherein the resource allocation of the scheduled physical channel comprises a RIV that includes an indication of a starting resource block of the resource allocation that is with reference to a first resource block of the uplink subband or a first resource block of the downlink subband.

Aspect 31: The method of any of aspects 22 through 30, wherein the uplink subband corresponds to a respective virtual uplink BWP and the downlink subband corresponds to a respective virtual downlink BWP, and wherein outputting the second information indicative of the SBFD configuration comprises: outputting an indication of a physical channel resource allocation configured with frequency hopping within the downlink subband, the uplink subband, or both, wherein the physical channel resource allocation indicates a starting resource block of each hop of the frequency hopping relative to a first resource block of the uplink subband, and wherein a resource block offset is based at least in part on a size of the uplink subband, the downlink subband, or both.

Aspect 32: The method of any of aspects 22 through 31, wherein outputting the second information indicative of the SBFD configuration comprises: outputting the second information indicative of the SBFD configuration in respective uplink and downlink BWP configurations for the uplink subband, the downlink subband, or both, wherein the SBFD configuration is indicated jointly in each uplink and downlink BWP configuration, or separately for each uplink and downlink BWP configuration.

Aspect 33: The method of aspect 32, wherein the SBFD configuration includes frequency location information for the uplink subband, the downlink subband, or both, one or more RIVs, subcarrier spacing information, time domain information, semi-persistent scheduling information, one or more uplink channel configurations, one or more downlink channel configurations, one or more uplink reference signal configurations, one or more downlink reference signal configurations or any combination thereof.

Aspect 34: The method of any of aspects 22 through 33, wherein the SBFD configuration including the uplink subband, the downlink subband or both, is configured in accordance with a common resource block grid of a cell configured for SBFD communications.

Aspect 35: The method of aspect 34, wherein the cell comprises a network carrier and an associated network carrier bandwidth, a carrier of the UE and the channel bandwidth of the UE, or both.

Aspect 36: The method of any of aspects 22 through 35, wherein communicating the one or more messages further comprises: communicating the one or more messages via frequency resources of the uplink subband, the downlink subband, or both, based at least in part on one or more PRBs that at least partially overlap with the respective uplink BWP, the respective downlink BWP, or both, of the SBFD configuration.

Aspect 37: The method of any of aspects 22 through 36, wherein outputting the second information indicative of the SBFD configuration comprises: outputting, while the UE is in a connected state, the second information indicative of the SBFD configuration via a serving cell configuration message, wherein the SBFD configuration comprises a time pattern or an indication of resources for SBFD communications.

Aspect 38: The method of any of aspects 22 through 37, wherein outputting the second information indicative of the SBFD configuration comprises: outputting, while the UE is in a connected state, the second information indicative of the SBFD configuration for each of the one or more BWP pairs, wherein the SBFD configuration comprises a time pattern or an indication of resources for SBFD communications.

Aspect 39: The method of any of aspects 22 through 38, wherein receiving the second information indicative of the SBFD configuration comprises: outputting, while the UE is in a connected state, an idle state, or an inactive state, the second information indicative of the SBFD configuration via a cell common configuration of a broadcast message, wherein the SBFD configuration comprises a time pattern or an indication of resources for SBFD communications.

Aspect 40: The method of any of aspects 22 through 39, wherein outputting the SBFD configuration comprises a SBFD pattern periodicity that is based at least in part on a time domain duplexing downlink and uplink periodicity.

Aspect 41: The method of any of aspects 22 through 40, wherein outputting the second information indicative of the SBFD configuration comprises: outputting the second information indicative of the SBFD configuration via one or more broadcast system information messages, wherein the uplink subband, the downlink subband, or both, are configured relative to an initial BWP, are configured based at least in part on a serving cell bandwidth, or both.

Aspect 42: A UE for wireless communications, comprising one or more memories storing processor-executable code, and one or more processors coupled with the one or more memories and individually or collectively operable to execute the code to cause the UE to perform a method of any of aspects 1 through 21.

Aspect 43: A UE for wireless communications, comprising at least one means for performing a method of any of aspects 1 through 21.

Aspect 44: A non-transitory computer-readable medium storing code for wireless communications, the code comprising instructions executable by one or more processors to perform a method of any of aspects 1 through 21.

Aspect 45: A network entity for wireless communications, comprising one or more memories storing processor-executable code, and one or more processors coupled with the one or more memories and individually or collectively operable to execute the code to cause the network entity to perform a method of any of aspects 22 through 41.

Aspect 46: A network entity for wireless communications, comprising at least one means for performing a method of any of aspects 22 through 41.

Aspect 47: A non-transitory computer-readable medium storing code for wireless communications, the code comprising instructions executable by one or more processors to perform a method of any of aspects 22 through 41.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first information indicative of one or more bandwidth part pairs configured for the UE, each bandwidth part pair of the one or more bandwidth part pairs comprising a respective uplink bandwidth part and a respective downlink bandwidth part that at least partially occupy a channel bandwidth of the UE;
receive second information indicative of a subband full duplex configuration for each of the one or more bandwidth part pairs, wherein the subband full duplex configuration indicates an uplink subband, a downlink subband or both, that corresponds to each of the one or more bandwidth part pairs; and
communicate one or more messages via the one or more bandwidth part pairs in accordance with the subband full duplex configuration.

2. The UE of claim 1, wherein, to receive the second information, the one or more processors are individually or collectively operable to execute the code to cause the UE to:
transmit an indication of one or more capabilities of the UE; and
receive, responsive to the indication, the second information indicative of the subband full duplex configuration, wherein the subband full duplex configuration is based at least in part on the one or more capabilities of the UE.

3. The UE of claim 1, wherein the subband full duplex configuration includes a resource indication value that indicates a resource allocation associated with the uplink subband, the downlink subband or both, and the resource indication value includes an indication of a starting resource block of the resource allocation and a quantity of resource blocks included in the resource allocation, wherein the starting resource block is indicated relative to a first physical resource block of a carrier bandwidth, relative to a first physical resource block of an active bandwidth part of the one or more bandwidth part pairs of the channel bandwidth of the UE, or both.

4. The UE of claim 1, wherein the uplink subband, the downlink subband, or both, are configured in an active bandwidth part pair of the one or more bandwidth part pairs.

5. The UE of claim 1, wherein the subband full duplex configuration is based at least in part on one or more capabilities of the UE, the one or more capabilities comprising a supported guard band size between the uplink subband and the downlink subband, a threshold size of the uplink subband, a threshold size of the downlink subband, or any combination thereof.

6. The UE of claim 1, wherein, to receive the second information indicative of the subband full duplex configuration, the one or more processors are individually or collectively operable to execute the code to cause the UE to:
receive an indication of a resource allocation of a scheduled physical channel for subband full duplex communications via a bitmap, wherein a resource block group size of the resource allocation is based at least in part on a size of the uplink subband, a size of the downlink subband, or both.

7. The UE of claim 1, wherein, to receive the second information indicative of the subband full duplex configuration, the one or more processors are individually or collectively operable to execute the code to cause the UE to:
receive an indication of a resource allocation of a scheduled physical channel at the uplink subband, the downlink subband or both, wherein the resource allocation of the scheduled physical channel comprises a resource indication value that includes an indication of a starting resource block of the resource allocation that is with reference to a first resource block of the uplink subband or a first resource block of the downlink subband.

8. The UE of claim 1, wherein, to receive the second information indicative of the subband full duplex configuration, the one or more processors are individually or collectively operable to execute the code to cause the UE to:
receive an indication of a physical channel resource allocation configured with frequency hopping within the downlink subband, the uplink subband, or both, wherein the physical channel resource allocation indicates a starting resource block of each hop of the frequency hopping relative to a first resource block of the uplink subband, and wherein a resource block offset is based at least in part on a size of the uplink subband, the downlink subband, or both.

9. The UE of claim 1, wherein, to receive the second information indicative of the subband full duplex configuration, the one or more processors are individually or collectively operable to execute the code to cause the UE to:
receive the second information indicative of the subband full duplex configuration in respective uplink and downlink bandwidth part configurations for the uplink subband, the downlink subband, or both, wherein the subband full duplex configuration is indicated jointly in each uplink and downlink bandwidth part configuration, or separately for each uplink and downlink bandwidth part configuration.

10. The UE of claim 9, wherein the subband full duplex configuration includes frequency location information for the uplink subband, the downlink subband, or both, one or more resource indication values, subcarrier spacing information, time domain information, semi-persistent scheduling information, one or more uplink channel configurations, one or more downlink channel configurations, one or more uplink reference signal configurations, one or more downlink reference signal configurations or any combination thereof.

11. The UE of claim 1, wherein the subband full duplex configuration including the uplink subband, the downlink subband or both, is configured in accordance with a common resource block grid of a cell configured for subband full duplex communications, wherein the cell comprises a network carrier and an associated network carrier bandwidth, a carrier of the UE and the channel bandwidth of the UE, or both.

12. The UE of claim 1, wherein, to communicate the one or more messages, the one or more processors are individually or collectively further operable to execute the code to cause the UE to:
communicate the one or more messages via frequency resources of the uplink subband, the downlink subband, or both, based at least in part on one or more physical resource blocks that at least partially overlap with the respective uplink bandwidth part, the respective downlink bandwidth part, or both, of the subband full duplex configuration.

13. The UE of claim 1, wherein the one or more processors are individually or collectively further operable to execute the code to cause the UE to:
drop one or more physical resource blocks of the respective uplink bandwidth part, the respective downlink bandwidth part, or both, based at least in part on a subcarrier spacing of the respective uplink bandwidth part, the respective downlink bandwidth part, or both, being greater than a corresponding subcarrier spacing of the uplink subband, the downlink subband, or both.

14. The UE of claim 1, wherein, to receive the second information indicative of the subband full duplex configuration, the one or more processors are individually or collectively operable to execute the code to cause the UE to:
receive, while the UE is in a connected state, the second information indicative of the subband full duplex configuration via a serving cell configuration message, wherein the subband full duplex configuration comprises a time pattern or an indication of resources for subband full duplex communications.

15. The UE of claim 1, wherein, to receive the second information indicative of the subband full duplex configuration, the one or more processors are individually or collectively operable to execute the code to cause the UE to:
receive, while the UE is in a connected state, the second information indicative of the subband full duplex configuration for each of the one or more bandwidth part pairs, wherein the subband full duplex configuration comprises a time pattern or an indication of resources for subband full duplex communications.

16. The UE of claim 1, wherein, to receive the second information indicative of the subband full duplex configuration, the one or more processors are individually or collectively operable to execute the code to cause the UE to:
receive, while the UE is in a connected state, an idle state, or an inactive state, the second information indicative of the subband full duplex configuration via a cell common configuration of a broadcast message, wherein the subband full duplex configuration comprises a time pattern or an indication of resources for subband full duplex communications.

17. The UE of claim 1, wherein receiving the subband full duplex configuration comprises a subband full duplex pattern periodicity that is based at least in part on a time division duplexing downlink and uplink periodicity.

18. The UE of claim 1, wherein the UE is operating in an inactive state or an idle state, and, to receive the second information indicative of the subband full duplex configuration, the one or more processors are individually or collectively operable to execute the code to cause the UE to:
receive the second information indicative of the subband full duplex configuration via one or more broadcast system information messages, wherein the uplink subband, the downlink subband, or both, are configured relative to an initial bandwidth part, are configured based at least in part on a serving cell bandwidth, or both.

19. A network entity, comprising:
one or more memories storing processor-executable code; and
one or more processors coupled with the one or more memories and individually or collectively operable to execute the code to cause the network entity to:
output first information indicative of one or more bandwidth part pairs configured for a user equipment (UE), each bandwidth part pair of the one or more bandwidth part pairs comprising a respective uplink bandwidth part and a respective downlink bandwidth part that at least partially occupy a channel bandwidth of the UE;
output second information indicative of a subband full duplex configuration for each of the one or more bandwidth part pairs, wherein the subband full duplex configuration indicates an uplink subband, a downlink subband or both, that corresponds to each of the one or more bandwidth part pairs; and
communicate one or more messages via the one or more bandwidth part pairs in accordance with the subband full duplex configuration.

20. A method for wireless communications at a user equipment (UE), comprising:
receiving first information indicative of one or more bandwidth part pairs configured for the UE, each bandwidth part pair of the one or more bandwidth part pairs comprising a respective uplink bandwidth part and a respective downlink bandwidth part that at least partially occupy a channel bandwidth of the UE;
receiving second information indicative of a subband full duplex configuration for each of the one or more bandwidth part pairs, wherein the subband full duplex configuration indicates an uplink subband, a downlink subband or both, that corresponds to each of the one or more bandwidth part pairs; and
communicating one or more messages via the one or more bandwidth part pairs in accordance with the subband full duplex configuration.
